(19) United States
(12) Patent Application Publication
(10) Pub. No.: US 2023/0344603 A1
(43) Pub. Date: Oct. 26, 2023

(54) SEPARATE UPLINK RESOURCES FOR FEEDBACK REPORT AND CHANNEL STATE INFORMATION REPORT WITH BEAM SWEEPING

(71) Applicant: QUALCOMM Incorporated, San Diego, CA (US)

(72) Inventors: Yan ZHOU, San Diego, CA (US); Hamed PEZESHKI, San Diego, CA (US); Konstantinos DIMOU, New York, NY (US); Tao LUO, San Diego, CA (US)

(21) Appl. No.: 18/002,766

(22) PCT Filed: Aug. 27, 2021
(86) PCT No.: PCT/US2021/047928

§ 371 Date: Dec. 21, 2022

(30) Foreign Application Priority Data
Sep. 4, 2020 (GR) 20200100540

(51) Int. Cl. H04W 72/044; H04B 7/0408; H04L 5/00; H04B 7/06

(52) U.S. Cl. CPC H04L 5/0055; H04B 7/0408; H04B 7/0626; H04W 72/046

(57) ABSTRACT

Various aspects of the present disclosure generally relate to wireless communication. In some aspects, a user equipment (UE) may receive downlink control information (DCI) that indicates a first uplink resource for an acknowledgement or negative acknowledgment feedback report and a second uplink resource for a channel state information report. The UE may receive, via the DCI, an indication of a first beam sweep pattern associated with the first uplink resource and a second beam sweep pattern associated with the second uplink resource. Numerous other aspects are provided.

### CROSS-REFERENCE TO RELATED APPLICATION

This Patent Application claims priority to Greek Patent Application No. 20200100540, filed on Sep. 4, 2020, entitled “SEPARATE UPLINK RESOURCES FOR FEEDBACK REPORT AND CHANNEL STATE INFORMATION REPORT WITH BEAM SWEEPING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for separate uplink resources for a feedback report and a channel state information (CSI) report with beam sweeping.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving downlink control information (DCI) that indicates a first uplink resource for an acknowledgement or negative acknowledgment (ACK/NACK) feedback report and a second uplink resource for a channel state information (CSI) report; and receiving, via the DCI, an indication of a first beam sweep pattern associated with the first uplink resource and a second beam sweep pattern associated with the second uplink resource.

In some aspects, a method of wireless communication performed by a base station includes transmitting, to a UE, DCI that indicates a first uplink resource for an ACK/NACK feedback report and a second uplink resource for a CSI report; and transmitting, to the UE via the DCI, an indication of a first beam sweep pattern associated with the first uplink resource and a second beam sweep pattern associated with the second uplink resource.

In some aspects, a UE for wireless communication includes a memory and one or more processors, coupled to the memory, configured to: receive DCI that indicates a first uplink resource for an ACK/NACK feedback report and a second uplink resource for a CSI report; and receive, via the DCI, an indication of a first beam sweep pattern associated with the first uplink resource and a second beam sweep pattern associated with the second uplink resource.

In some aspects, a base station for wireless communication includes a memory; and one or more processors, coupled to the memory, configured to: transmit, to a UE, DCI that indicates a first uplink resource for an ACK/NACK feedback report and a second uplink resource for a CSI report; and transmit, to the UE via the DCI, an indication of a first beam sweep pattern associated with the first uplink resource and a second beam sweep pattern associated with the second uplink resource.

In some aspects, a non-transitory computer-readable medium storing a set of instructions for wireless communication includes one or more instructions that, when executed by one or more processors of a UE, cause the UE to: receive DCI that indicates a first uplink resource for an ACK/NACK feedback report and a second uplink resource for a CSI report; and receive, via the DCI, an indication of a first beam sweep pattern associated with the first uplink resource and a second beam sweep pattern associated with the second uplink resource.

In some aspects, a non-transitory computer-readable medium storing a set of instructions for wireless communication includes one or more instructions that, when executed by one or more processors of a base station, cause the base station to: transmit, to a UE, DCI that indicates a first uplink resource for an ACK/NACK feedback report and a second uplink resource for a CSI report; and transmit, to the UE via the DCI, an indication of a first beam sweep pattern associated with the first uplink resource and a second beam sweep pattern associated with the second uplink resource.

In some aspects, an apparatus for wireless communication includes means for receiving DCI that indicates a first uplink resource for an ACK/NACK feedback report and a second uplink resource for a CSI report; and means for receiving, via the DCI, an indication of a first beam sweep pattern associated with the first uplink resource and a second beam sweep pattern associated with the second uplink resource.

In some aspects, an apparatus for wireless communication includes means for transmitting, to a UE, DCI that indicates a first uplink resource for an ACK/NACK feedback report and a second uplink resource for a CSI report; and means for transmitting, to the UE via the DCI, an indication of a first beam sweep pattern associated with the first uplink resource and a second beam sweep pattern associated with the second uplink resource.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of downlink control information (DCI) that schedules multiple communications, in accordance with the present disclosure.

FIG. 4 is a diagram illustrating an example of using beams for communications between a base station and a UE, in accordance with the present disclosure.

FIG. 5 is a diagram illustrating an example associated with separate uplink resources for a feedback report and a channel state information (CSI) report with beam sweeping, in accordance with the present disclosure.

FIGS. 6 and 7 are diagrams illustrating example processes associated with separate uplink resources for a feedback report and a CSI report with beam sweeping, in accordance with the present disclosure.

FIGS. 8 and 9 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

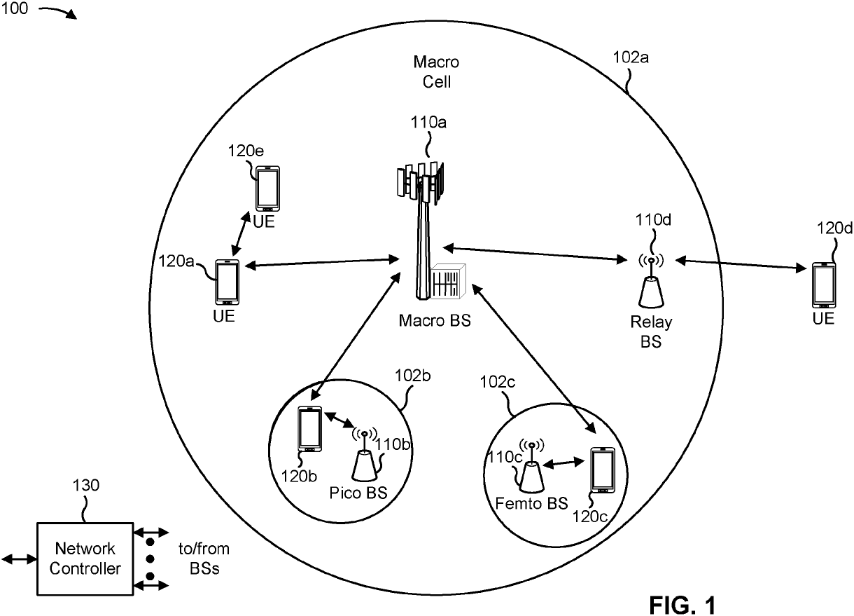

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz - 300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

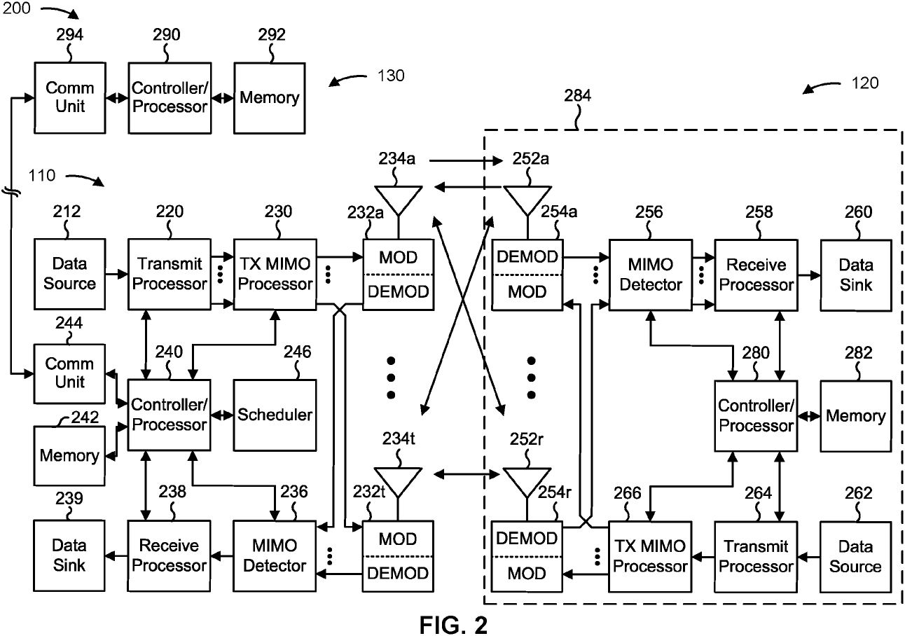

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T ≥ 1 and R ≥ 1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

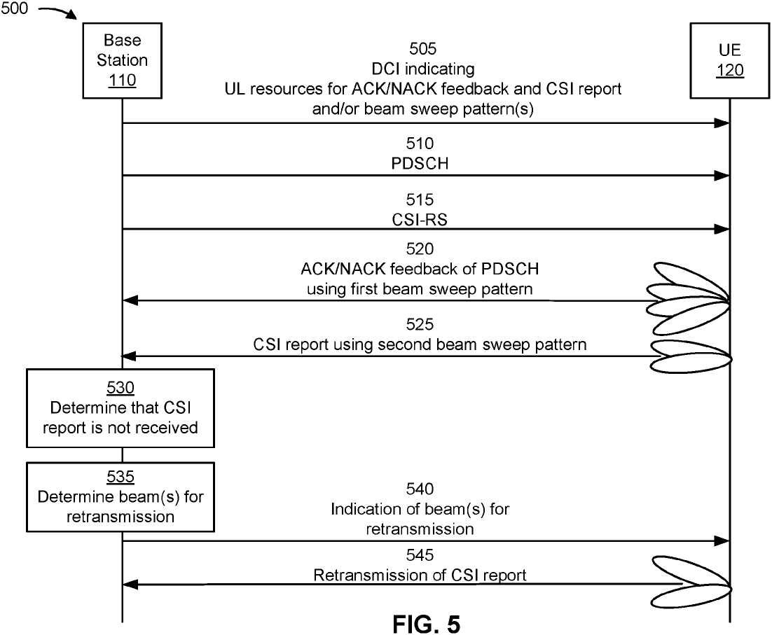

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 5-9).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 5-9).

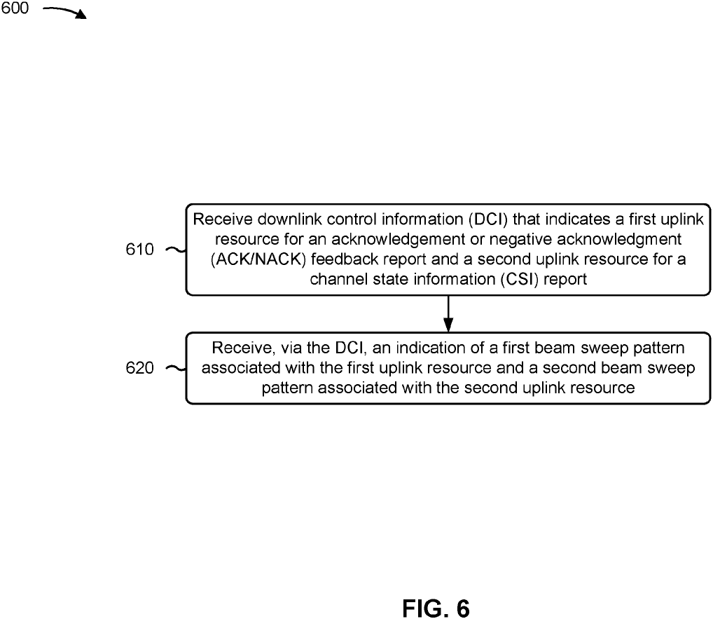

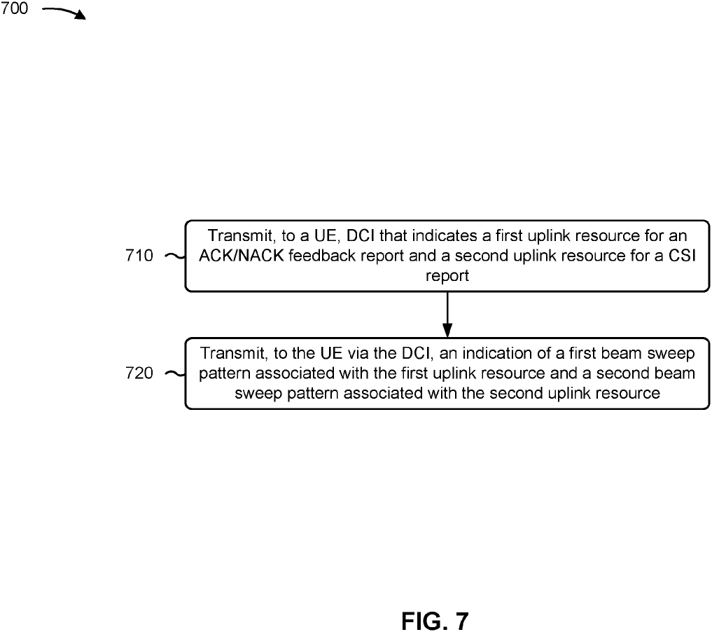

Controller/processor 240 of base station 110, controller/processor 280 of UE 120, and/or any other component(s) of FIG. 2 may perform one or more techniques associated with separate uplink resources for a feedback report and a CSI report with beam sweeping, as described in more detail elsewhere herein. For example, controller/processor 240 of base station 110, controller/processor 280 of UE 120, and/or any other component(s) of FIG. 2 may perform or direct operations of, for example, process 600 of FIG. 6, process 700 of FIG. 7, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some aspects, executing instructions may include running the instructions, converting the instructions, compiling the instructions, and/or interpreting the instructions, among other examples.

In some aspects, the UE 120 includes means for receiving DCI that indicates a first uplink resource for an ACK/NACK feedback report and a second uplink resource for a CSI report and/or means for receiving, via the DCI, an indication of a first beam sweep pattern associated with the first uplink resource and a second beam sweep pattern associated with the second uplink resource. The means for the UE 120 to perform operations described herein may include, for example, antenna 252, demodulator 254, MIMO detector 256, receive processor 258, transmit processor 264, TX MIMO processor 266, modulator 254, controller/processor 280, and/or memory 282.

In some aspects, the UE 120 includes means for transmitting the ACK/NACK feedback report on the first uplink resource in accordance with the first beam sweep pattern, and/or means for transmitting the CSI report on the second uplink resource in accordance with the second beam sweep pattern. In some aspects, the UE 120 includes means for receiving an indication to retransmit the ACK/NACK feedback report or the CSI report using a third beam sweep pattern. In some aspects, the UE 120 includes means for retransmitting the ACK/NACK feedback report or the CSI report in accordance with the third beam sweep pattern.

In some aspects, the UE 120 includes means for receiving an indication that the first uplink resource is a single uplink resource, and/or means for receiving an indication that the second uplink resource is a single uplink resource. In some aspects, the UE 120 includes means for receiving an indication that the first beam sweep pattern includes a set of beams that occupy different resources of the single uplink resource associated with the first uplink resource, and/or means for receiving an indication that the second beam sweep pattern includes a set of beams that occupy different resources of the single uplink resource associated with the second uplink resource. In some aspects, the UE 120 includes means for determining an uplink transmit power associated with transmitting a set of beams on the single uplink resource associated with the first uplink resource based at least in part on a downlink pathloss reference signal associated with the first uplink resource. In some aspects, the UE 120 includes means for determining an uplink transmit power associated with transmitting a set of beams on the single uplink resource associated with the second uplink resource based at least in part on a downlink pathloss reference signal associated with the second uplink resource.

In some aspects, the UE 120 includes means for receiving an indication that the first uplink resource includes multiple uplink resources, and/or means for receiving an indication that the second uplink resource includes multiple uplink resources. In some aspects, the UE 120 includes means for receiving the indication of the first beam sweep pattern including an indication of a beam sweep pattern for each uplink resource of the multiple uplink resources associated with the first uplink resource, and/or means for receiving the indication of the second beam sweep pattern including an indication of a beam sweep pattern for each uplink resource of the multiple uplink resources associated with the second uplink resource. In some aspects, the UE 120 includes means for determining, for each uplink resource of the multiple uplink resources associated with the first uplink resource, an uplink transmit power based at least in part on a downlink pathloss reference signal associated with an uplink resource of the multiple uplink resources. In some aspects, the UE 120 includes means for determining, for each uplink resource of the multiple uplink resources associated with the second uplink resource, an uplink transmit power based at least in part on a downlink pathloss reference signal associated with an uplink resource of the multiple uplink resources.

In some aspects, the UE 120 includes means for receiving a set of parameters associated with the first beam sweep pattern, and/or means for receiving a set of parameters associated with the second beam sweep pattern. In some aspects, the UE 120 includes means for receiving a first subset of parameters, of the set of parameters, via the DCI, and/or means for receiving a second subset of parameters, of the set of parameters, via a radio resource control configuration. In some aspects, the UE 120 includes means for receiving a first subset of parameters of the set of parameters via the DCI, and/or means for receiving a second subset of parameters of the set of parameters via a radio resource control configuration.

In some aspects, the UE 120 includes means for receiving an indication of a plurality of beam sweep patterns via a radio resource control (RRC) configuration, wherein the RRC configuration indicates an index value associated with each beam sweep pattern of the plurality of beam sweep patterns. In some aspects, the UE 120 includes means for receiving, via the DCI, an indication of an index value associated with the first beam sweep pattern, and/or means for receiving, via the DCI, an indication of an index value associated with the second beam sweep pattern. In some aspects, the UE 120 includes means for receiving, via medium access control (MAC) control element (MAC-CE) signaling or DCI signaling, one or more updated beam sweep patterns.

In some aspects, the base station 110 includes means for transmitting, to a UE, DCI that indicates a first uplink resource for an ACK/NACK feedback report and a second uplink resource for a CSI report, and/or means for transmitting, to the UE via the DCI, an indication of a first beam sweep pattern associated with the first uplink resource and a second beam sweep pattern associated with the second uplink resource. The means for the base station 110 to perform operations described herein may include, for example, transmit processor 220, TX MIMO processor 230, modulator 232, antenna 234, demodulator 232, MIMO detector 236, receive processor 238, controller/processor 240, memory 242, and/or scheduler 246.

In some aspects, the base station 110 includes means for receiving the ACK/NACK feedback report on the first uplink resource in accordance with the first beam sweep pattern, and/or means for receiving the CSI report on the second uplink resource in accordance with the second beam sweep pattern.

In some aspects, the base station 110 includes means for determining that the ACK/NACK feedback report or the CSI report was not successfully received. In some aspects, the base station 110 includes means for determining a third beam sweep pattern for a retransmission of the ACK/NACK feedback report or the CSI report, and/or means for transmitting, to the UE, an indication to retransmit the ACK/NACK feedback report or the CSI report using the third beam sweep pattern. In some aspects, the base station 110 includes means for determining that the ACK/NACK feedback report was successfully received, and/or means for determining that the CSI report was not successfully received. In some aspects, the base station 110 includes means for determining one or more beams on which the ACK/NACK feedback report was successfully received, and/or means for determining a third beam sweep pattern for the retransmission of the CSI report that includes the one or more beams on which the ACK/NACK feedback report was successfully received.

In some aspects, the base station 110 includes means for determining that the CSI report was successfully received, and/or means for determining that the ACK/NACK feedback report was not successfully received. In some aspects, the base station 110 includes means for determining one or more beams on which the CSI report was successfully received, and/or means for determining a third beam sweep pattern for the retransmission of the ACK/NACK feedback report that includes the one or more beams on which the CSI report was successfully received. In some aspects, the base station 110 includes means for receiving a retransmission of the ACK/NACK feedback report or the CSI report in accordance with the third beam sweep pattern.

In some aspects, the base station 110 includes means for transmitting an indication that the first uplink resource is a single uplink resource, and/or means for transmitting an indication that the second uplink resource is a single uplink resource.

In some aspects, the base station 110 includes means for transmitting an indication that the first beam sweep pattern includes a set of beams that occupy different resources of the single uplink resource associated with the first uplink resource, and/or means for transmitting an indication that the second beam sweep pattern includes a set of beams that occupy different resources of the single uplink resource associated with the second uplink resource.

In some aspects, the base station 110 includes means for transmitting a downlink pathloss reference signal associated with the first uplink resource, wherein the downlink pathloss reference signal associated with the first uplink resource is used by the UE to determine an uplink transmit power associated with transmitting a set of beams on the single uplink resource associated with the first uplink resource.

In some aspects, the base station 110 includes means for transmitting a downlink pathloss reference signal associated with the second uplink resource, wherein the downlink pathloss reference signal associated with the second uplink resource is used by the UE to determine an uplink transmit power associated with transmitting a set of beams on the single uplink resource associated with the second uplink resource.

In some aspects, the base station 110 includes means for transmitting an indication that the first uplink resource includes multiple uplink resources, and/or means for transmitting an indication that the second uplink resource includes multiple uplink resources.

In some aspects, the base station 110 includes means for transmitting the indication of the first beam sweep pattern including an indication of a beam sweep pattern for each uplink resource of the multiple uplink resources associated with the first uplink resource, and/or means for transmitting the indication of the second beam sweep pattern including an indication of a beam sweep pattern for each uplink resource of the multiple uplink resources associated with the second uplink resource.

In some aspects, the base station 110 includes means for transmitting, for each uplink resource of the multiple uplink resources associated with the first uplink resource, a downlink pathloss reference signal, wherein the downlink pathloss reference signal is used by the UE to determine an uplink transmit power associated with an uplink resource of the multiple uplink resources.

In some aspects, the base station 110 includes means for transmitting, for each uplink resource of the multiple uplink resources associated with the second uplink resource, a downlink pathloss reference signal, wherein the downlink pathloss reference signal is used by the UE to determine an uplink transmit power associated with an uplink resource of the multiple uplink resources.

In some aspects, the base station 110 includes means for transmitting a set of parameters associated with the first beam sweep pattern, and/or means for transmitting a set of parameters associated with the second beam sweep pattern.

In some aspects, the base station 110 includes means for transmitting a first subset of parameters, of the set of parameters, via the DCI, and/or means for transmitting a second subset of parameters, of the set of parameters, via a radio resource control configuration.

In some aspects, the base station 110 includes means for transmitting a first subset of parameters of the set of parameters via the DCI, and/or means for transmitting a second subset of parameters of the set of parameters via a radio resource control configuration.

In some aspects, the base station 110 includes means for transmitting an indication of a plurality of beam sweep patterns via an RRC configuration, wherein the RRC configuration indicates an index value associated with each beam sweep pattern of the plurality of beam sweep patterns.

In some aspects, the base station 110 includes means for transmitting, via the DCI, an indication of an index value associated with the first beam sweep pattern, and/or means for transmitting, via the DCI, an indication of an index value associated with the second beam sweep pattern.

In some aspects, the base station 110 includes means for determining to update one or more of the plurality of beam sweep patterns, and/or means for transmitting, via MAC-CE signaling or DCI signaling, one or more updated beam sweep patterns.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

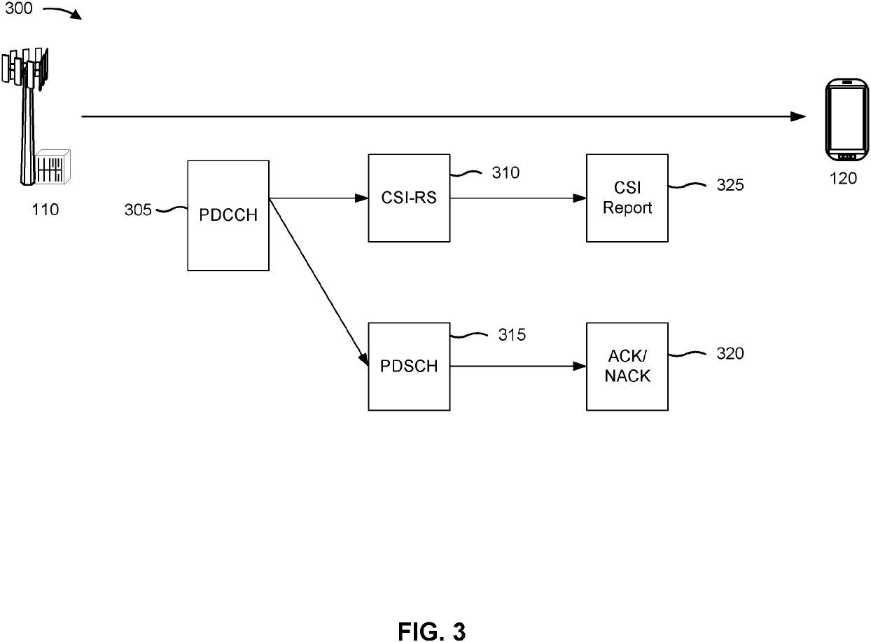

FIG. 3 is a diagram illustrating an example 300 of DCI that schedules multiple communications, in accordance with various aspects of the present disclosure. As shown in FIG. 3, a base station 110 and a UE 120 may communicate with one another. In some aspects, the base station 110 and the UE 120 may be included in a wireless network, such as wireless network 100. The base station 110 and the UE 120 may communicate on a wireless access link, which may include an uplink and a downlink.

The base station 110 may transmit, to the UE 120, a physical downlink control channel (PDCCH) communication 305 that includes DCI. The DCI may schedule multiple communications for the UE 120. For example, the DCI may schedule a transmission of a CSI reference signal (CSI-RS) 310. The CSI-RS 310 may be an aperiodic CSI-RS in that the CSI-RS 310 is dynamically triggered by the DCI in PDCCH communication 305. In some aspects, the CSI-RS 310 may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a CQI, a precoding matrix indicator (PMI), a CSI-RS resource indicator (CRI), a layer indicator (LI), a rank indicator (RI), or an RSRP, among other examples. The base station 110 may use the CSI report to select transmission parameters for downlink communications to the UE 120, such as a number of transmission layers (e.g., a rank), a precoding matrix (e.g., a precoder), an MCS, and/or a refined downlink beam (e.g., using a beam refinement procedure or a beam management procedure), among other examples.

The DCI included in PDCCH communication 305 may also schedule a data communication, such as physical downlink shared channel (PDSCH) communication 315. The PDSCH communication 315 may be a dynamic grant PDSCH communication in that it is triggered or scheduled by the DCI included in the PDCCH communication 305.

In example 300, the DCI included in the PDCCH communication 305 may also indicate scheduling information for uplink communications to be transmitted by the UE 120. The scheduling information may indicate a resource to be used for acknowledgement (ACK) or negative acknowledgement (NACK) feedback (e.g., ACK/NACK feedback or ACK/NACK information) associated with a communication scheduled by the DCI. For example, the scheduling information may indicate one or more uplink resources for ACK/NACK feedback 320 that is associated with the PDSCH communication 315. The one or more uplink resources for ACK/NACK feedback 320 may be uplink control resources (e.g., one or more physical uplink control channel (PUCCH) resources and/or the like). For example, the ACK/NACK feedback 320 may be indicated in uplink control information (UCI) carried on a PUCCH resource.

In some aspects, the scheduling information in the DCI may indicate one or more uplink resources for a CSI report 325. The CSI report 325 may indicate one or more channel estimation parameters, described above, to the base station 110. In some aspects, the one or more uplink resources for the CSI report 325 may be the same as the one or more uplink resources for ACK/NACK feedback 320 (e.g., both the ACK/NACK feedback 320 and the CSI report 325 may be included in the same uplink resources). In some aspects, the one or more uplink resources for the CSI report 325 may be different than the one or more uplink resources for ACK/NACK feedback 320 (e.g., the ACK/NACK feedback 320 may be transmitted using a PUCCH resource and the CSI report may be transmitted using a physical uplink shared channel (PUSCH) resource or a different PUCCH resource).

In some cases, scheduling information in the DCI may be indicated once and reused for multiple communications. For example, the DCI may schedule multiple semi-persistent or periodic downlink communications. The scheduling information may indicate uplink resource(s) for the ACK/NACK feedback 320 for the semi-persistent or periodic downlink communications. The UE 120 may reuse the scheduling information for the ACK/NACK feedback 320 at each instance of the semi-persistent or periodic downlink communications. Similarly, the UE 120 may reuse scheduling information associated with the CSI report 325 for future CSI reports. In this way, the base station 110 and the UE 120 may conserve signaling overhead associated with scheduling the communications.

As indicated above, FIG. 3 is provided as an example. Other examples may differ from what is described with respect to FIG. 3.

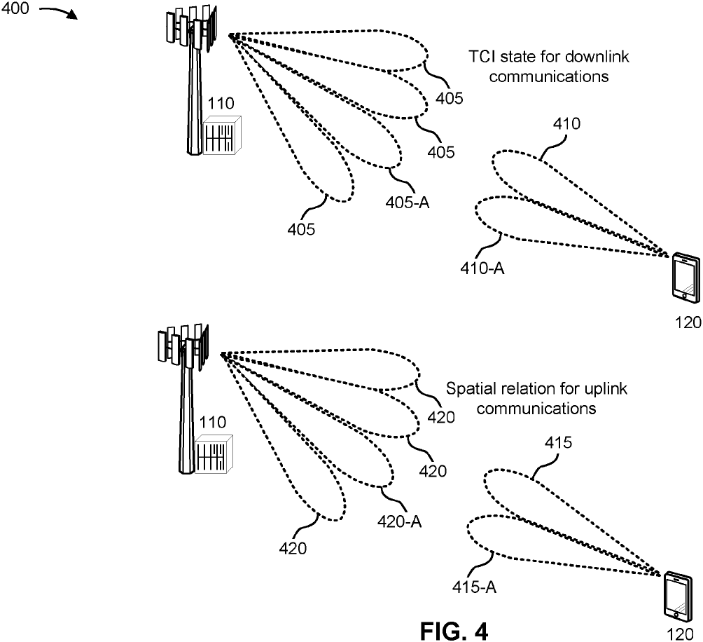

FIG. 4 is a diagram illustrating an example 400 of using beams for communications between a base station and a UE, in accordance with various aspects of the present disclosure. As shown in FIG. 4, a base station 110 and a UE 120 may communicate with one another. In some aspects, the base station 110 and the UE 120 may be included in a wireless network, such as wireless network 100. The base station 110 and the UE 120 may communicate on a wireless access link, which may include an uplink and a downlink.

The base station 110 may transmit to UEs 120 located within a coverage area of the base station 110. The base station 110 and the UE 120 may be configured for beamformed communications, where the base station 110 may transmit in the direction of the UE 120 using a directional base station transmit beam, and the UE 120 may receive the transmission using a directional UE receive beam. Each base station transmit beam may have an associated beam ID, beam direction, or beam symbols, among other examples. The base station 110 may transmit downlink communications via one or more base station transmit beams 405.

The UE 120 may attempt to receive downlink transmissions via one or more UE receive beams 410, which may be configured using different beamforming parameters at receive circuitry of the UE 120. The UE 120 may identify a particular base station transmit beam 405, shown as base station transmit beam 405-A, and a particular UE receive beam 410, shown as UE receive beam 410-A, that provide relatively favorable performance (for example, that have a best channel quality of the different measured combinations of base station transmit beams 405 and UE receive beams 410). In some examples, the UE 120 may transmit an indication of which base station transmit beam 405 is identified by the UE 120 as a preferred base station transmit beam, which the base station 110 may select for transmissions to the UE 120. The UE 120 may thus attain and maintain a beam pair link (BPL) with the base station 110 for downlink communications (for example, a combination of the base station transmit beam 405-A and the UE receive beam 410-A), which may be further refined and maintained in accordance with one or more established beam refinement procedures.

A downlink beam, such as a base station transmit beam 405 or a UE receive beam 410, may be associated with a transmission configuration indicator (TCI) state. A TCI state may indicate a directionality or a characteristic of the downlink beam, such as one or more quasi-co-location (QCL) properties of the downlink beam. A QCL property may include, for example, a Doppler shift, a Doppler spread, an average delay, a delay spread, or spatial receive parameters, among other examples. In some examples, each base station transmit beam 405 may be associated with a synchronization signal block (SSB), and the UE 120 may indicate a preferred base station transmit beam 405 by transmitting uplink transmissions in resources of the SSB that are associated with the preferred base station transmit beam 405. A particular SSB may have an associated TCI state (for example, for an antenna port or for beamforming). The base station 110 may, in some examples, indicate a downlink base station transmit beam 405 based at least in part on antenna port QCL properties that may be indicated by the TCI state. A TCI state may be associated with one downlink reference signal set (for example, an SSB and an aperiodic, periodic, or semi-persistent CSI-RS) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 410 at the UE 120. Thus, the UE 120 may select a corresponding UE receive beam 410 from a set of BPLs based at least in part on the base station 110 indicating a base station transmit beam 405 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a PDSCH. The set of activated TCI states for downlink control channel communications may correspond to beams that the base station 110 may use for downlink transmission on a PDCCH or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as an RRC message.

Similarly, for uplink communications, the UE 120 may transmit in the direction of the base station 110 using a directional UE transmit beam, and the base station 110 may receive the transmission using a directional base station receive beam. Each UE transmit beam may have an associated beam ID, beam direction, or beam symbols, among other examples. The UE 120 may transmit uplink communications via one or more UE transmit beams 415.

The base station 110 may receive uplink transmissions via one or more base station receive beams 420. The base station 110 may identify a particular UE transmit beam 415, shown as UE transmit beam 415-A, and a particular base station receive beam 420, shown as base station receive beam 420-A, that provide relatively favorable performance (for example, that have a best channel quality of the different measured combinations of UE transmit beams 415 and base station receive beams 420). In some examples, the base station 110 may transmit an indication of which UE transmit beam 415 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 415-A and the base station receive beam 420-A), which may be further refined and maintained in accordance with one or more established beam refinement procedures. An uplink beam, such as a UE transmit beam 415 or a base station receive beam 420, may be associated with a spatial relation. A spatial relation may indicate a directionality or a characteristic of the uplink beam, similar to one or more QCL properties, as described above. In some aspects, an uplink beam may be associated with an uplink TCI state (e.g., in a similar manner as described above with respect to the downlink TCI states).

As indicated above, FIG. 4 is provided as an example. Other examples may differ from what is described with respect to FIG. 4.

In some cases, communication of traffic within a wireless network, such as the wireless network 100, may be associated with strict latency requirements and/or strict reliability requirements. For example, traffic provided by ultra-reliability low latency communication (URLLC) services, traffic associated with an industrial IoT (IIoT) scenario, traffic associated with factory automation, among other example use cases, may be associated with latency requirements and/or reliability requirements.

In some cases, a single DCI communication may schedule an ACK/NACK feedback report and an aperiodic CSI report on separate uplink resources (e.g., as described above with respect to FIG. 3). In some cases, a successful transmission of an ACK/NACK feedback report and/or a CSI report may be important for ensuring the reliability requirements and/or the latency requirements of communications are satisfied. For example, if an ACK/NACK feedback report was not successfully transmitted by a UE 120, a base station 110 may be unaware of whether a downlink communication was successfully transmitted (or there may be a delay in notifying the base station 110 of whether the downlink communication was successfully transmitted associated with retransmitting the ACK/NACK feedback report). As a result, if an ACK/NACK feedback report and/or a CSI report was not successfully transmitted, the latency requirements and/or reliability requirements of communications within the network may not be satisfied.

Some techniques and apparatuses described herein enable separate uplink resources to be used for an ACK/NACK feedback report and a CSI report with beam sweeping. For example, the single DCI that schedules the ACK/NACK feedback report and the CSI report on different uplink resources may also indicate a first beam sweep pattern for transmitting the ACK/NACK feedback report and a second beam sweep pattern for transmitting the CSI report. A beam sweep pattern may indicate a set of beams to be used for transmitting a communication. As a result, a reliability of the uplink communications (e.g., the ACK/NACK feedback report and the CSI report) is improved by transmitting the uplink communications using a beam sweep pattern (e.g., by transmitting the uplink communications on multiple uplink transmit beams).

Moreover, indicating a beam sweep pattern for each uplink resource provides additional flexibility, enabling the UE 120 and the base station 110 to conserve resources associated with transmitting the uplink resources. For example, the ACK/NACK feedback report and the CSI report may be associated with different levels of importance for maintaining the latency requirements and/or reliability requirements of communications within the network. The base station 110 may configure a first uplink resource with a robust beam sweep pattern (e.g., using more beams, more repetitions, stronger uplink transmit power, among other examples) to improve reliability of a communication (e.g., the ACK/NACK feedback report) transmitted on the first uplink resource. The base station 110 may configure a second uplink resource with a less robust beam sweep pattern (e.g., using less beams, less repetitions, and/or a lower uplink transmit power, among other examples) to conserve resources associated with transmitting a communication (e.g., the CSI report) on the second uplink resource (e.g., where the communication transmitted on the second uplink resource is associated with a lower importance for maintaining the latency requirements and/or reliability requirements of communications within the network). Additionally, reliability of the communication (e.g., the CSI report) on the second uplink resource is improved when compared to transmitting the communication without using beam sweeping.

If the communication transmitted on the second uplink resource was not successfully received by the base station 110, the base station 110 may reschedule a transmission of the communication using good beams (e.g., beams associated with higher signal strength or signal quality) identified in the transmission of the communication on the first uplink resource (e.g., that used the more robust beam sweep pattern). In this way, the base station 110 and the UE 120 may conserve resources while also ensuring that the latency requirements and/or reliability requirements of communications within the network are satisfied.

FIG. 5 is a diagram illustrating an example 500 associated with separate uplink resources for a feedback report and a CSI report with beam sweeping, in accordance with various aspects of the present disclosure. As shown in FIG. 5, a base station 110 and a UE 120 may communicate with one another. In some aspects, the base station 110 and the UE 120 may be included in a wireless network, such as wireless network 100. In some aspects, the wireless network may be an IIoT wireless network. The base station 110 and the UE 120 may communicate on a wireless access link, which may include an uplink and a downlink.

As shown by reference number 505, the base station 110 may transmit, and the UE 120 may receive, DCI indicating a first uplink resource for an ACK/NACK feedback report and a second uplink resource for a CSI report. The first uplink resource and the second uplink resource may be different uplink resources. The uplink resources (e.g., the first uplink resource and/or the second uplink resource) may be a PUCCH resource or a PUSCH resource. In some aspects, the CSI report may be an aperiodic CSI report (e.g., triggered by DCI that schedules a transmission of an aperiodic CSI-RS).

The DCI may schedule a transmission, by the base station 110, of a downlink data communication (e.g., a PDSCH communication) and an aperiodic CSI-RS. The ACK/NACK feedback report may be associated with the downlink data communication. The CSI report may be associated with the aperiodic CSI-RS. In some aspects, the DCI may schedule the downlink data communication, the aperiodic CSI-RS, the ACK/NACK feedback report, and/or the CSI report in a similar (or the same) manner as described above with respect to FIG. 3.

The DCI may indicate a first beam sweep pattern associated with the first uplink resource and a second beam sweep pattern associated with the second uplink resource. The beam sweep patterns (e.g., the first beam sweep pattern and/or the second beam sweep pattern) may indicate a set of beams that the UE 120 is to use for transmitting a communication on the associated uplink resource. In some aspects, the first beam sweep pattern may be the same as the second beam sweep pattern (e.g., the DCI may indicate the same beam sweep pattern for the first uplink resource and the second uplink resource and/or the DCI may indicate a single beam sweep pattern and indicate that the single beam sweep pattern is to be used for both the first uplink resource and the second uplink resource). In some aspects, the first beam sweep pattern may be different than the second beam sweep pattern.

In some aspects, the first beam sweep pattern for transmitting the ACK/NACK feedback report may be more robust than the second beam sweep pattern for transmitting the CSI report. For example, the first beam sweep pattern may be associated with more beams, more repetitions, a stronger uplink transmit power, among other examples, than the second beam sweep pattern. In this way, a reliability of the ACK/NACK feedback report is increased. Moreover, resources associated with transmitting the CSI report may be conserved when compared to the first beam sweep pattern (e.g., as the CSI report may have a lower importance for maintaining the latency requirements and/or reliability requirements of communications within the network) while also improving reliability of the CSI report when compared to transmitting the CSI report without beam sweeping.

In some aspects, the beam sweep patterns may be time division multiplexing (TDM) beam sweep patterns, frequency division multiplexing (FDM) beam sweep patterns, and/or spatial division multiplexing (SDM) beam sweep patterns. For example, the beam sweep patterns may be TDM patterns, FDM patterns, and/or SDM patterns across multiple beams. In some aspects, a beam included in a beam sweep pattern may be indicated by spatial relation information and/or an uplink TCI state, among other examples.

In some aspects, the beam sweep patterns may indicate that a beam included in a beam sweep pattern is to be repeated in a different time domain resource (e.g., in a different symbol) and/or in a different frequency domain resource (e.g., in a different resource block).

In some aspects, an uplink resource (e.g., the first uplink resource and/or the second uplink resource) may include a single uplink resource or multiple uplink resources. In the case where the uplink resource includes a single uplink resource, a beam sweep pattern associated with the uplink resource may indicate that different beams occupy different portions (e.g., different time domain resources, different frequency domain resources, and/or different spatial domain resources) of the uplink resources. For example, a beam sweep pattern may indicate a first beam and a second beam. The beam sweep pattern may indicate that the first beam occupies a first set of resources associated with the uplink resource (e.g., a first time domain resource, a first frequency domain resource, and/or a first spatial domain resource). The beam sweep pattern may indicate that the second beam occupies a second set of resources associated with the uplink resource (e.g., a second time domain resource, a second frequency domain resource, and/or a second spatial domain resource).

In some aspects, an uplink resource (e.g., the first uplink resource and/or the second uplink resource) that includes only a single uplink resource may be associated with a single downlink pathloss reference signal. For example, the base station 110 may indicate (e.g., in the DCI or in another downlink communication) the downlink pathloss reference signal associated with the uplink resource. The base station 110 may transmit, and the UE 120 may receive, the downlink pathloss reference signal. The UE 120 may use the downlink pathloss reference signal to determine an uplink transmit power associated with the uplink resource. As a result, all beams associated with the uplink resource may be transmitted using a same uplink transmit power.

In the case where the uplink resource (e.g., the first uplink resource and/or the second uplink resource) includes multiple uplink resources, a beam sweep pattern associated with the uplink resource may indicate a set of beams per uplink resource of the multiple uplink resource. In other words, the beam sweep pattern may indicate beams for each uplink resource, of the multiple uplink resources, in a similar manner as described above with respect to the single uplink resource (e.g., each uplink resource, of the multiple uplink resources, may be associated with a set of beams that occupy different resources of the uplink resource). In some aspects, each uplink resource, of the multiple uplink resources, may be associated with a downlink pathloss reference signal (e.g., the first uplink resource and/or the second uplink resource may be associated with multiple downlink pathloss reference signals corresponding to the multiple uplink resources).

For example, the base station 110 may indicate (e.g., in the DCI or in another downlink communication) the multiple downlink pathloss reference signals associated with the uplink resource (e.g., the first uplink resource and/or the second uplink resource). The base station 110 may transmit, and the UE 120 may receive, the downlink pathloss reference signals. The UE 120 may use a downlink pathloss reference signal to determine an uplink transmit power associated with a corresponding uplink resource of the multiple uplink resources. As a result, uplink transmit power may be determined on a per uplink resource basis when the first uplink resource and/or the second uplink resource includes multiple uplink resources.

In some aspects, the DCI may fully indicate the beam sweep patterns (e.g., the first beam sweep pattern and/or the second beam sweep pattern). For example, a beam sweep pattern may be associated with a set of parameters, such as an uplink resource type (e.g., PUCCH and/or PUSCH), an uplink resource identifier, a quantity of uplink resources, a resource allocation per uplink resource, a quantity of repetitions per uplink resource, a UE panel identifier per beam, and/or a downlink pathloss reference signal for each uplink resource, among other examples. In some aspects, the DCI may indicate all parameters associated with a beam sweep pattern (e.g., the first beam sweep pattern and/or the second beam sweep pattern).

In some aspects, the DCI may partially indicate the beam sweep patterns. For example, a subset of parameters of a beam sweep pattern may be configured by the base station 110 using RRC signaling. The remaining parameters of a beam sweep pattern (e.g., the parameters not configured using RRC signaling) may be indicated by the DCI.

In some aspects, the base station 110 may configure the UE 120 with multiple beam sweep patterns using RRC signaling. For example, the base station 110 may indicate multiple beam sweep patterns (e.g., indicating a set of parameters associated with each beam sweep pattern). The base station 110 may indicate an index value associated with each beam sweep pattern of the multiple beam sweep patterns. The DCI may indicate a beam sweep pattern (e.g., the first beam sweep pattern and/or the second beam sweep pattern) by indicating an index value associated with the beam sweep pattern. The base station 110 may dynamically update the RRC configured beam sweep patterns using MAC-CE signaling or DCI signaling. For example, the base station 110 may change (e.g., add or remove) an uplink resource associated with a beam sweep pattern using MAC-CE signaling and/or DCI signaling.

As shown by reference number 510, the base station 110 may transmit, and the UE 120 may receive, the downlink data communication (e.g., a dynamic grant PDSCH communication) that was scheduled by the DCI. As shown by reference number 515, the base station 110 may transmit, and the UE 120 may receive, the aperiodic CSI-RS that was scheduled by the DCI.

As shown by reference number 520, the UE 120 may transmit the ACK/NACK feedback report associated with the downlink data communication on the first uplink resource and in accordance with the first beam sweep pattern. For example, the UE 120 may determine whether the downlink data communication has been successfully received (e.g., based at least in part on attempting to decode the downlink data communication). If the UE 120 determines that the downlink data communication has been successfully received, the UE 120 may transmit ACK feedback on the first uplink resource in accordance with the first beam sweep pattern. If the UE 120 determines that the downlink data communication has not been successfully received, the UE 120 may transmit NACK feedback on the first uplink resource in accordance with the first beam sweep pattern. The UE 120 may determine one or more uplink transmit powers for transmitting the ACK/NACK feedback report based at least in part on one or more downlink pathloss reference signals associated with the first uplink resource, as described above.

As shown by reference number 525, the UE 120 may transmit the CSI report on the second uplink resource and in accordance with the second beam sweep pattern. For example, the UE 120 may receive the aperiodic CSI-RS. The UE 120 may measure the aperiodic CSI-RS using one or more UE receive beams. Based at least in part on the measurements, the UE 120 may perform channel estimation and may report channel estimation parameters to the base station 110 (e.g., in the CSI report). The UE 120 may determine one or more uplink transmit powers for transmitting the CSI report based at least in part on one or more downlink pathloss reference signals associated with the second uplink resource, as described above.

As shown by reference number 530, the base station 110 may determine that the CSI report has not been successfully received. For example, the base station 110 may attempt to receive the ACK/NACK feedback report and the CSI report. The base station 110 may determine that at least one of the ACK/NACK feedback report or the CSI report has not been successfully received. As a result, the base station 110 may determine that the uplink communication that has not been successfully received should be retransmitted by the UE 120.

As shown by reference number 535, the base station 110 may determine one or more beams (e.g., one or more BPLs, one or more UE transmit beams, and/or one or more base station receive beams) to be used for the retransmission of the CSI report that has not been successfully received by the base station 110. In some aspects, the base station 110 may determine the one or more beams based at least in part on the reception of the ACK/NACK feedback report. For example, the base station 110 may successfully receive the ACK/NACK feedback report and may not successfully receive the CSI report. The base station 110 may identify one or more good beams (e.g., beams associated with good channel estimation parameters, and/or beams on which the ACK/NACK feedback report was successfully communicated, among other examples) based at least in part on the reception of the ACK/NACK feedback report. The base station 110 may determine that the CSI report is to be retransmitted by the UE 120 using the one or more good beams identified from the reception of the ACK/NACK feedback report. The base station 110 may determine one or more beams for a transmission of the ACK/NACK feedback report in a similar manner if the CSI report was successfully received and the ACK/NACK feedback report was not successfully received (e.g., based at least in part on one or more good beams associated with a reception of the CSI report). In some aspects, the base station 110 may determine a different beam sweep pattern (e.g., a third beam sweep pattern) that includes the one or more beams that are to be used for the retransmission of the uplink communication that has not been successfully received by the base station 110. The different beam sweep pattern may indicate one or more beams included in the first beam sweep pattern (e.g., the beam sweep patter used to transmit the ACK/NACK feedback report that was successfully received).

As shown by reference number 540, the base station 110 may transmit, and the UE 120 may receive, an indication of the one or more beams to be used for a retransmission of the CSI report that has not been successfully received by the base station 110. For example, the base station 110 may reschedule the CSI report and indicate the one or more beams that are to be used for retransmitting the uplink communication. In some aspects, the base station 110 may indicate the different beam sweep pattern (e.g., the third beam sweep pattern) associated with retransmitting the uplink communication that has not been successfully received by the base station 110. In some aspects, the base station 110 may indicate one or more uplink resources and the one or more beams to be used for the retransmission of the uplink communication that has not been successfully received by the base station 110. In some aspects, the base station 110 may indicate the one or more uplink resources and the one or more beams to be used for the retransmission of the uplink communication in a DCI communication. As shown by reference number 545, the UE 120 may transmit, and the base station 110 may receive, the retransmission of the CSI report using the one or more beams (or the different beam sweep pattern) indicated by the base station 110.

As a result, a reliability of the uplink communications (e.g., the ACK/NACK feedback report and the CSI report) is improved by transmitting the uplink communications using a beam sweep pattern (e.g., by transmitting the uplink communications on multiple uplink transmit beams). Moreover, indicating a beam sweep pattern per uplink resource provides additional flexibility, enabling the UE 120 and the base station 110 to conserve resources associated with transmitting the uplink resources (e.g., where the ACK/NACK feedback report and the CSI report are associated with different levels of importance for maintaining the latency requirements and/or reliability requirements of communications within the network). Configuring a first uplink resource with a more robust beam sweep pattern (e.g., using more beams, more repetitions, stronger uplink transmit power, among other examples) and a second uplink resource with a less robust beam sweep pattern (e.g., using less beams, less repetitions, and/or a lower uplink transmit power, among other examples) conserves resources associated with transmitting a communication (e.g., the CSI report) on the second uplink resource (e.g., where the communication transmitted on the second uplink resource is associated with a lower importance for maintaining the latency requirements and/or reliability requirements of communications within the network) when compared with transmitting the communication on the first uplink resource using the more robust beam sweep pattern. Additionally, reliability of the communication (e.g., the CSI report) on the second uplink resource is still improved when compared to transmitting the communication without using beam sweeping. In this way, the base station 110 and the UE 120 may conserve resources while also ensuring that the latency requirements and/or reliability requirements of communications within the network are satisfied.

As indicated above, FIG. 5 is provided as an example. Other examples may differ from what is described with respect to FIG. 5.

FIG. 6 is a diagram illustrating an example process 600 performed, for example, by a UE, in accordance with various aspects of the present disclosure. Example process 600 is an example where the UE (e.g., UE 120) performs operations associated with separate uplink resources for a feedback report and a CSI report with beam sweeping.

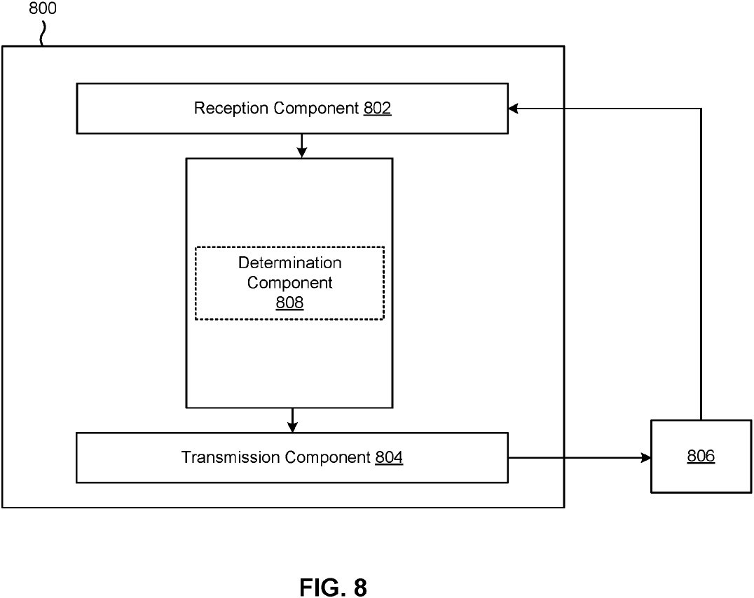

As shown in FIG. 6, in some aspects, process 600 may include receiving DCI that indicates a first uplink resource for an ACK/NACK feedback report and a second uplink resource for a CSI report (block 610). For example, the UE (e.g., using reception component 802, depicted in FIG. 8) may receive DCI that indicates a first uplink resource for an ACK/NACK feedback report and a second uplink resource for a CSI report, as described above.

As further shown in FIG. 6, in some aspects, process 600 may include receiving, via the DCI, an indication of a first beam sweep pattern associated with the first uplink resource and a second beam sweep pattern associated with the second uplink resource (block 620). For example, the UE (e.g., using reception component 802, depicted in FIG. 8) may receive, via the DCI, an indication of a first beam sweep pattern associated with the first uplink resource and a second beam sweep pattern associated with the second uplink resource, as described above.

Process 600 may include additional aspects, such as any single aspect or any combination of aspects described below and/or in connection with one or more other processes described elsewhere herein.

In a first aspect, the DCI schedules a downlink communication and an aperiodic CSI-RS.

In a second aspect, alone or in combination with the first aspect, the ACK/NACK feedback report is associated with the downlink communication, and the CSI report is associated with the aperiodic CSI-RS.

In a third aspect, alone or in combination with one or more of the first and second aspects, the first uplink resource or the second uplink resource are at least one of a physical uplink control channel resource or a physical uplink shared channel resource.

In a fourth aspect, alone or in combination with one or more of the first through third aspects, the first beam sweep pattern is the same as the second beam sweep pattern.

In a fifth aspect, alone or in combination with one or more of the first through fourth aspects, the first beam sweep pattern is different than the second beam sweep pattern.

In a sixth aspect, alone or in combination with one or more of the first through fifth aspects, the first beam sweep pattern indicates a first set of beams associated with transmitting the ACK/NACK feedback report on the first uplink resource, and the second beam sweep pattern indicates a second set of beams associated with transmitting the CSI report on the second uplink resource.

In a seventh aspect, alone or in combination with one or more of the first through sixth aspects, process 600 includes transmitting the ACK/NACK feedback report on the first uplink resource in accordance with the first beam sweep pattern, and transmitting the CSI report on the second uplink resource in accordance with the second beam sweep pattern.

In an eighth aspect, alone or in combination with one or more of the first through seventh aspects, process 600 includes receiving an indication to retransmit the CSI report using a third beam sweep pattern.

In a ninth aspect, alone or in combination with one or more of the first through eighth aspects, the third beam sweep pattern is based at least in part on a transmission of the ACK/NACK feedback report using the first beam sweep pattern.

In a tenth aspect, alone or in combination with one or more of the first through ninth aspects, the third beam sweep pattern indicates one or more beams included in the first beam sweep pattern.

In an eleventh aspect, alone or in combination with one or more of the first through tenth aspects, process 600 includes retransmitting the CSI report in accordance with the third beam sweep pattern.

In a twelfth aspect, alone or in combination with one or more of the first through eleventh aspects, the first beam sweep pattern or the second beam sweep pattern is at least one of a time division multiplexing beam sweep pattern, a frequency division multiplexing beam sweep pattern, or a spatial division multiplexing beam sweep pattern.

In a thirteenth aspect, alone or in combination with one or more of the first through twelfth aspects, the first beam sweep pattern indicates a first set of one or more beams using indications of transmission configuration indicator states or spatial relation information for the first set of one or more beams, and the second beam sweep pattern indicates a second set of one or more beams using indications of transmission configuration indicator states or spatial relation information for the second set of one or more beams.

In a fourteenth aspect, alone or in combination with one or more of the first through thirteenth aspects, at least one of the first beam sweep pattern or the second beam sweep pattern indicates that one or more beams are to be repeated in at least one of different time domain resources or different frequency domain resources.

In a fifteenth aspect, alone or in combination with one or more of the first through fourteenth aspects, receiving the DCI that indicates the first uplink resource for the ACK/NACK feedback report and the second uplink resource for the CSI report comprises at least one of receiving an indication that the first uplink resource is a single uplink resource, or receiving an indication that the second uplink resource is a single uplink resource.

In a sixteenth aspect, alone or in combination with one or more of the first through fifteenth aspects, receiving, via the DCI, the indication of the first beam sweep pattern associated with the first uplink resource and the second beam sweep pattern associated with the second uplink resource comprises at least one of receiving an indication that the first beam sweep pattern includes a set of beams that occupy different resources of the single uplink resource associated with the first uplink resource, or receiving an indication that the second beam sweep pattern includes a set of beams that occupy different resources of the single uplink resource associated with the second uplink resource.

In a seventeenth aspect, alone or in combination with one or more of the first through sixteenth aspects, different resources of the single uplink resource include at least one of different time domain resources of the single uplink resource, different frequency domain resources of the single uplink resource, or different spatial directions associated with the single uplink resource.

In an eighteenth aspect, alone or in combination with one or more of the first through seventeenth aspects, process 600 includes determining an uplink transmit power associated with transmitting a set of beams on the single uplink resource associated with the first uplink resource based at least in part on a downlink pathloss reference signal associated with the first uplink resource.

In a nineteenth aspect, alone or in combination with one or more of the first through eighteenth aspects, process 600 includes determining an uplink transmit power associated with transmitting a set of beams on the single uplink resource associated with the second uplink resource based at least in part on a downlink pathloss reference signal associated with the second uplink resource.

In a twentieth aspect, alone or in combination with one or more of the first through nineteenth aspects, receiving the DCI that indicates the first uplink resource for the ACK/NACK feedback report and the second uplink resource for the CSI report comprises at least one of: receiving an indication that the first uplink resource includes multiple uplink resources, or receiving an indication that the second uplink resource includes multiple uplink resources.

In a twenty-first aspect, alone or in combination with one or more of the first through twentieth aspects, receiving, via the DCI, the indication of the first beam sweep pattern associated with the first uplink resource and the second beam sweep pattern associated with the second uplink resource comprises at least one of: receiving the indication of the first beam sweep pattern including an indication of a beam sweep pattern for each uplink resource of the multiple uplink resources associated with the first uplink resource, or receiving the indication of the second beam sweep pattern including an indication of a beam sweep pattern for each uplink resource of the multiple uplink resources associated with the second uplink resource.

In a twenty-second aspect, alone or in combination with one or more of the first through twenty-first aspects, process 600 includes determining, for each uplink resource of the multiple uplink resources associated with the first uplink resource, an uplink transmit power based at least in part on a downlink pathloss reference signal associated with an uplink resource of the multiple uplink resources.

In a twenty-third aspect, alone or in combination with one or more of the first through twenty-second aspects, process 600 includes determining, for each uplink resource of the multiple uplink resources associated with the second uplink resource, an uplink transmit power based at least in part on a downlink pathloss reference signal associated with an uplink resource of the multiple uplink resources.

In a twenty-fourth aspect, alone or in combination with one or more of the first through twenty-third aspects, receiving, via the DCI, the indication of the first beam sweep pattern associated with the first uplink resource and the second beam sweep pattern associated with the second uplink resource comprises receiving a set of parameters associated with the first beam sweep pattern, and receiving a set of parameters associated with the second beam sweep pattern.

In a twenty-fifth aspect, alone or in combination with one or more of the first through twenty-fourth aspects, the set of parameters associated with the first beam sweep pattern and the set of parameters associated with the second beam sweep pattern indicate at least one of: an uplink resource type, an uplink resource identifier, a quantity of uplink resources, a resource allocation per uplink resource, a quantity of repetitions per uplink resource, a panel identifier per beam, or a downlink pathloss reference signal per uplink resource.

In a twenty-sixth aspect, alone or in combination with one or more of the first through twenty-fifth aspects, receiving the set of parameters associated with the first beam sweep pattern comprises receiving a first subset of parameters, of the set of parameters, via the DCI, and receiving a second subset of parameters, of the set of parameters, via a radio resource control configuration.

In a twenty-seventh aspect, alone or in combination with one or more of the first through twenty-sixth aspects, receiving the set of parameters associated with the second beam sweep pattern comprises receiving a first subset of parameters of the set of parameters via the DCI, and receiving a second subset of parameters of the set of parameters via a radio resource control configuration.

In a twenty-eighth aspect, alone or in combination with one or more of the first through twenty-seventh aspects, process 600 includes receiving an indication of a plurality of beam sweep patterns via an RRC configuration, wherein the RRC configuration indicates an index value associated with each beam sweep pattern of the plurality of beam sweep patterns.

In a twenty-ninth aspect, alone or in combination with one or more of the first through twenty-eighth aspects, receiving, via the DCI, the indication of the first beam sweep pattern associated with the first uplink resource and the second beam sweep pattern associated with the second uplink resource comprises receiving, via the DCI, an indication of an index value associated with the first beam sweep pattern, and receiving, via the DCI, an indication of an index value associated with the second beam sweep pattern.

In a thirtieth aspect, alone or in combination with one or more of the first through twenty-ninth aspects, process 600 includes receiving, via MAC-CE signaling or DCI signaling, one or more updated beam sweep patterns.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with various aspects of the present disclosure. Example process 700 is an example where the base station (e.g., base station 110) performs operations associated with separate uplink resources for a feedback report and a CSI report with beam sweeping.

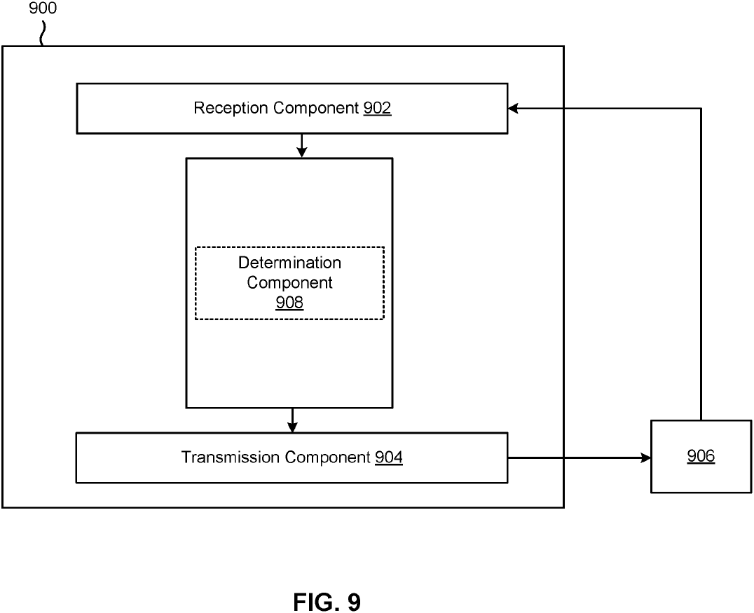

As shown in FIG. 7, in some aspects, process 700 may include transmitting, to a UE, DCI that indicates a first uplink resource for an ACK/NACK feedback report and a second uplink resource for a CSI report (block 710). For example, the base station (e.g., using transmission component 904, depicted in FIG. 9) may transmit, to a UE, DCI that indicates a first uplink resource for an ACK/NACK feedback report and a second uplink resource for a CSI report, as described above.

As further shown in FIG. 7, in some aspects, process 700 may include transmitting, to the UE via the DCI, an indication of a first beam sweep pattern associated with the first uplink resource and a second beam sweep pattern associated with the second uplink resource (block 720). For example, the base station (e.g., using transmission component 904, depicted in FIG. 9) may transmit, to the UE via the DCI, an indication of a first beam sweep pattern associated with the first uplink resource and a second beam sweep pattern associated with the second uplink resource, as described above.

Process 700 may include additional aspects, such as any single aspect or any combination of aspects described below and/or in connection with one or more other processes described elsewhere herein.

In a first aspect, the DCI schedules a downlink communication and an aperiodic CSI-RS.

In a second aspect, alone or in combination with the first aspect, the ACK/NACK feedback report is associated with the downlink communication, and the CSI report is associated with the aperiodic CSI-RS.

In a third aspect, alone or in combination with one or more of the first and second aspects, the first uplink resource or the second uplink resource are at least one of a physical uplink control channel resource or a physical uplink shared channel resource.

In a fourth aspect, alone or in combination with one or more of the first through third aspects, the first beam sweep pattern is the same as the second beam sweep pattern.

In a fifth aspect, alone or in combination with one or more of the first through fourth aspects, the first beam sweep pattern is different than the second beam sweep pattern.

In a sixth aspect, alone or in combination with one or more of the first through fifth aspects, the first beam sweep pattern indicates a first set of beams associated with transmitting the ACK/NACK feedback report on the first uplink resource, and the second beam sweep pattern indicates a second set of beams associated with transmitting the CSI report on the second uplink resource.

In a seventh aspect, alone or in combination with one or more of the first through sixth aspects, process 700 includes receiving the ACK/NACK feedback report on the first uplink resource in accordance with the first beam sweep pattern, and receiving the CSI report on the second uplink resource in accordance with the second beam sweep pattern.

In an eighth aspect, alone or in combination with one or more of the first through seventh aspects, process 700 includes determining that the CSI report was not successfully received.

In a ninth aspect, alone or in combination with one or more of the first through eighth aspects, process 700 includes determining a third beam sweep pattern for a retransmission of the CSI report, and transmitting, to the UE, an indication to retransmit the CSI report using the third beam sweep pattern.

In a tenth aspect, alone or in combination with one or more of the first through ninth aspects, determining that the CSI report was not successfully received comprises determining that the ACK/NACK feedback report was successfully received, and determining that the CSI report was not successfully received, wherein determining the third beam sweep pattern for the retransmission of the ACK/NACK feedback report or the CSI report comprises determining one or more beams on which the ACK/NACK feedback report was successfully received, and determining a third beam sweep pattern for the retransmission of the CSI report that includes the one or more beams on which the ACK/NACK feedback report was successfully received.

In an eleventh aspect, alone or in combination with one or more of the first through tenth aspects, process 700 includes receiving a retransmission of the ACK/NACK feedback report or the CSI report in accordance with the third beam sweep pattern.

In a twelfth aspect, alone or in combination with one or more of the first through eleventh aspects, the first beam sweep pattern or the second beam sweep pattern is at least one of a time division multiplexing beam sweep pattern, a frequency division multiplexing beam sweep pattern, or a spatial division multiplexing beam sweep pattern.

In a thirteenth aspect, alone or in combination with one or more of the first through twelfth aspects, the first beam sweep pattern indicates a first set of one or more beams using indications of transmission configuration indicator states or spatial relation information for the first set of one or more beams, and the second beam sweep pattern indicates a second set of one or more beams using indications of transmission configuration indicator states or spatial relation information for the second set of one or more beams.

In a fourteenth aspect, alone or in combination with one or more of the first through thirteenth aspects, at least one of the first beam sweep pattern or the second beam sweep pattern indicates that one or more beams are to be repeated in at least one of different time domain resources or different frequency domain resources.

In a fifteenth aspect, alone or in combination with one or more of the first through fourteenth aspects, transmitting the DCI that indicates the first uplink resource for the ACK/NACK feedback report and the second uplink resource for the CSI report comprises at least one of transmitting an indication that the first uplink resource is a single uplink resource, or transmitting an indication that the second uplink resource is a single uplink resource.

In a sixteenth aspect, alone or in combination with one or more of the first through fifteenth aspects, transmitting, via the DCI, the indication of the first beam sweep pattern associated with the first uplink resource and the second beam sweep pattern associated with the second uplink resource comprises at least one of: transmitting an indication that the first beam sweep pattern includes a set of beams that occupy different resources of the single uplink resource associated with the first uplink resource, or transmitting an indication that the second beam sweep pattern includes a set of beams that occupy different resources of the single uplink resource associated with the second uplink resource.

In a seventeenth aspect, alone or in combination with one or more of the first through sixteenth aspects, different resources of the single uplink resource include at least one of: different time domain resources of the single uplink resource, different frequency domain resources of the single uplink resource, or different spatial directions associated with the single uplink resource.

In an eighteenth aspect, alone or in combination with one or more of the first through seventeenth aspects, process 700 includes transmitting a downlink pathloss reference signal associated with the first uplink resource, wherein the downlink pathloss reference signal associated with the first uplink resource is used by the UE to determine an uplink transmit power associated with transmitting a set of beams on the single uplink resource associated with the first uplink resource.

In a nineteenth aspect, alone or in combination with one or more of the first through eighteenth aspects, process 700 includes transmitting a downlink pathloss reference signal associated with the second uplink resource, wherein the downlink pathloss reference signal associated with the second uplink resource is used by the UE to determine an uplink transmit power associated with transmitting a set of beams on the single uplink resource associated with the second uplink resource.

In a twentieth aspect, alone or in combination with one or more of the first through nineteenth aspects, transmitting the DCI that indicates the first uplink resource for the ACK/NACK feedback report and the second uplink resource for the CSI report comprises at least one of transmitting an indication that the first uplink resource includes multiple uplink resources, or transmitting an indication that the second uplink resource includes multiple uplink resources.

In a twenty-first aspect, alone or in combination with one or more of the first through twentieth aspects, transmitting, via the DCI, the indication of the first beam sweep pattern associated with the first uplink resource and the second beam sweep pattern associated with the second uplink resource comprises at least one of: transmitting the indication of the first beam sweep pattern including an indication of a beam sweep pattern for each uplink resource of the multiple uplink resources associated with the first uplink resource, or transmitting the indication of the second beam sweep pattern including an indication of a beam sweep pattern for each uplink resource of the multiple uplink resources associated with the second uplink resource.

In a twenty-second aspect, alone or in combination with one or more of the first through twenty-first aspects, process 700 includes transmitting, for each uplink resource of the multiple uplink resources associated with the first uplink resource, a downlink pathloss reference signal, wherein the downlink pathloss reference signal is used by the UE to determine an uplink transmit power associated with an uplink resource of the multiple uplink resources.

In a twenty-third aspect, alone or in combination with one or more of the first through twenty-second aspects, process 700 includes transmitting, for each uplink resource of the multiple uplink resources associated with the second uplink resource, a downlink pathloss reference signal, wherein the downlink pathloss reference signal is used by the UE to determine an uplink transmit power associated with an uplink resource of the multiple uplink resources.

In a twenty-fourth aspect, alone or in combination with one or more of the first through twenty-third aspects, transmitting, via the DCI, the indication of the first beam sweep pattern associated with the first uplink resource and the second beam sweep pattern associated with the second uplink resource comprises transmitting a set of parameters associated with the first beam sweep pattern, and transmitting a set of parameters associated with the second beam sweep pattern.

In a twenty-fifth aspect, alone or in combination with one or more of the first through twenty-fourth aspects, the set of parameters associated with the first beam sweep pattern and the set of parameters associated with the second beam sweep pattern indicate at least one of: an uplink resource type, an uplink resource identifier, a quantity of uplink resources, a resource allocation per uplink resource, a quantity of repetitions per uplink resource, a panel identifier per beam, or a downlink pathloss reference signal per uplink resource.

In a twenty-sixth aspect, alone or in combination with one or more of the first through twenty-fifth aspects, transmitting the set of parameters associated with the first beam sweep pattern comprises transmitting a first subset of parameters, of the set of parameters, via the DCI, and transmitting a second subset of parameters, of the set of parameters, via a radio resource control configuration.

In a twenty-seventh aspect, alone or in combination with one or more of the first through twenty-sixth aspects, transmitting the set of parameters associated with the second beam sweep pattern comprises transmitting a first subset of parameters of the set of parameters via the DCI, and transmitting a second subset of parameters of the set of parameters via a radio resource control configuration.

In a twenty-eighth aspect, alone or in combination with one or more of the first through twenty-seventh aspects, process 700 includes transmitting an indication of a plurality of beam sweep patterns via an RRC configuration, wherein the RRC configuration indicates an index value associated with each beam sweep pattern of the plurality of beam sweep patterns.

In a twenty-ninth aspect, alone or in combination with one or more of the first through twenty-eighth aspects, transmitting, via the DCI, the indication of the first beam sweep pattern associated with the first uplink resource and the second beam sweep pattern associated with the second uplink resource comprises transmitting, via the DCI, an indication of an index value associated with the first beam sweep pattern, and transmitting, via the DCI, an indication of an index value associated with the second beam sweep pattern.

In a thirtieth aspect, alone or in combination with one or more of the first through twenty-ninth aspects, process 700 includes determining to update one or more of the plurality of beam sweep patterns, and transmitting, via MAC-CE signaling or DCI signaling, one or more updated beam sweep patterns.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a block diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a determination component 808, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the UE described above in connection with FIG. 2. Additionally, or alternatively, one or more components shown in FIG. 8 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 806. In some aspects, the reception component 802 may include one or more antennas, a demodulator, a MIMO detector, a receive processor, a controller/processor, a memory, or a combination thereof, of the UE described above in connection with FIG. 2.

The transmission component 804 may transmit communications, such as reference signals, control information, data communications, or a combination thereof, to the apparatus 806. In some aspects, one or more other components of the apparatus 806 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modulator, a transmit MIMO processor, a transmit processor, a controller/processor, a memory, or a combination thereof, of the UE described above in connection with FIG. 2. In some aspects, the transmission component 804 may be collocated with the reception component 802 in a transceiver.

The reception component 802 may receive DCI that indicates a first uplink resource for an ACK/NACK feedback report and a second uplink resource for a CSI report. The reception component 802 may receive, via the DCI, an indication of a first beam sweep pattern associated with the first uplink resource and a second beam sweep pattern associated with the second uplink resource.

The transmission component 804 may transmit the ACK/NACK feedback report on the first uplink resource in accordance with the first beam sweep pattern, and/or transmit the CSI report on the second uplink resource in accordance with the second beam sweep pattern. The reception component 802 may receive an indication to retransmit the ACK/NACK feedback report or the CSI report using a third beam sweep pattern. The transmission component 804 may retransmit the ACK/NACK feedback report or the CSI report in accordance with the third beam sweep pattern.

The reception component 802 may receive an indication that the first uplink resource is a single uplink resource, and/or may receive an indication that the second uplink resource is a single uplink resource. The reception component 802 may receive an indication that the first beam sweep pattern includes a set of beams that occupy different resources of the single uplink resource associated with the first uplink resource, and/or may receive an indication that the second beam sweep pattern includes a set of beams that occupy different resources of the single uplink resource associated with the second uplink resource.

The determination component 808 may determine an uplink transmit power associated with transmitting a set of beams on the single uplink resource associated with the first uplink resource based at least in part on a downlink pathloss reference signal associated with the first uplink resource. In some aspects, the determination component 808 may include a receive processor, a transmit MIMO processor, a transmit processor, a controller/processor, a memory, or a combination thereof, of the UE described above in connection with FIG. 2. The determination component 808 may determine an uplink transmit power associated with transmitting a set of beams on the single uplink resource associated with the second uplink resource based at least in part on a downlink pathloss reference signal associated with the second uplink resource.

The reception component 802 may receive an indication that the first uplink resource includes multiple uplink resources, and/or may receive an indication that the second uplink resource includes multiple uplink resources. The reception component 802 may receive the indication of the first beam sweep pattern including an indication of a beam sweep pattern for each uplink resource of the multiple uplink resources associated with the first uplink resource, and/or may receive the indication of the second beam sweep pattern including an indication of a beam sweep pattern for each uplink resource of the multiple uplink resources associated with the second uplink resource. The determination component 808 may determine, for each uplink resource of the multiple uplink resources associated with the first uplink resource, an uplink transmit power based at least in part on a downlink pathloss reference signal associated with an uplink resource of the multiple uplink resources. The determination component 808 may determine, for each uplink resource of the multiple uplink resources associated with the second uplink resource, an uplink transmit power based at least in part on a downlink pathloss reference signal associated with an uplink resource of the multiple uplink resources.

The reception component 802 may receive a set of parameters associated with the first beam sweep pattern, and/or may receive a set of parameters associated with the second beam sweep pattern. The reception component 802 may receive a first subset of parameters, of the set of parameters, via the DCI, and/or may receive a second subset of parameters, of the set of parameters, via an RRC configuration. The reception component 802 may receive a first subset of parameters of the set of parameters via the DCI, and/or may receive a second subset of parameters of the set of parameters via an RRC configuration.

The reception component 802 may receive an indication of a plurality of beam sweep patterns via an RRC configuration, wherein the RRC configuration indicates an index value associated with each beam sweep pattern of the plurality of beam sweep patterns. The reception component 802 may receive, via the DCI, an indication of an index value associated with the first beam sweep pattern, and/or may receive, via the DCI, an indication of an index value associated with the second beam sweep pattern. The reception component 802 may receive, via MAC-CE signaling or DCI signaling, one or more updated beam sweep patterns.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a block diagram of an example apparatus 900 for wireless communication. The apparatus 900 may be a base station, or a base station may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a determination component 908, among other examples.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the base station described above in connection with FIG. 2. Additionally, or alternatively, one or more components shown in FIG. 9 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the base station described above in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the base station described above in connection with FIG. 2. In some aspects, the transmission component 904 may be collocated with the reception component 902 in a transceiver.

The transmission component 904 may transmit, to a UE, DCI that indicates a first uplink resource for an ACK/NACK feedback report and a second uplink resource for a CSI report. The transmission component 904 may transmit, to the UE via the DCI, an indication of a first beam sweep pattern associated with the first uplink resource and a second beam sweep pattern associated with the second uplink resource.

The reception component 902 may receive the ACK/NACK feedback report on the first uplink resource in accordance with the first beam sweep pattern, and/or may receive the CSI report on the second uplink resource in accordance with the second beam sweep pattern.

The determination component 908 may determine that the ACK/NACK feedback report or the CSI report was not successfully received. In some aspects, the determination component 908 may include a receive processor, a transmit MIMO processor, a transmit processor, a controller/processor, a memory, or a combination thereof, of the base station described above in connection with FIG. 2. The determination component 908 may determine a third beam sweep pattern for a retransmission of the ACK/NACK feedback report or the CSI report. The transmission component 904 may transmit, to the UE, an indication to retransmit the ACK/NACK feedback report or the CSI report using the third beam sweep pattern. The determination component 908 may determine that the ACK/NACK feedback report was successfully received, and may determine that the CSI report was not successfully received. The determination component 908 may determine one or more beams on which the ACK/NACK feedback report was successfully received, and/or may determine a third beam sweep pattern for the retransmission of the CSI report that includes the one or more beams on which the ACK/NACK feedback report was successfully received.

The determination component 908 may determine that the CSI report was successfully received. The determination component 908 may determine that the ACK/NACK feedback report was not successfully received. The determination component 908 may determine one or more beams on which the CSI report was successfully received. The determination component 908 may determine a third beam sweep pattern for the retransmission of the ACK/NACK feedback report that includes the one or more beams on which the CSI report was successfully received. The reception component 902 may receive a retransmission of the ACK/NACK feedback report or the CSI report in accordance with the third beam sweep pattern.

The transmission component 904 may transmit an indication that the first uplink resource is a single uplink resource, and/or may transmit an indication that the second uplink resource is a single uplink resource.

The transmission component 904 may transmit an indication that the first beam sweep pattern includes a set of beams that occupy different resources of the single uplink resource associated with the first uplink resource, and/or may transmit an indication that the second beam sweep pattern includes a set of beams that occupy different resources of the single uplink resource associated with the second uplink resource.

The transmission component 904 may transmit a downlink pathloss reference signal associated with the first uplink resource, wherein the downlink pathloss reference signal associated with the first uplink resource is used by the UE to determine an uplink transmit power associated with transmitting a set of beams on the single uplink resource associated with the first uplink resource.

The transmission component 904 may transmit a downlink pathloss reference signal associated with the second uplink resource, wherein the downlink pathloss reference signal associated with the second uplink resource is used by the UE to determine an uplink transmit power associated with transmitting a set of beams on the single uplink resource associated with the second uplink resource.

The transmission component 904 may transmit an indication that the first uplink resource includes multiple uplink resources, and/or may transmit an indication that the second uplink resource includes multiple uplink resources.

The transmission component 904 may transmit the indication of the first beam sweep pattern including an indication of a beam sweep pattern for each uplink resource of the multiple uplink resources associated with the first uplink resource, and/or may transmit the indication of the second beam sweep pattern including an indication of a beam sweep pattern for each uplink resource of the multiple uplink resources associated with the second uplink resource.

The transmission component 904 may transmit, for each uplink resource of the multiple uplink resources associated with the first uplink resource, a downlink pathloss reference signal, wherein the downlink pathloss reference signal is used by the UE to determine an uplink transmit power associated with an uplink resource of the multiple uplink resources. The transmission component 904 may transmit, for each uplink resource of the multiple uplink resources associated with the second uplink resource, a downlink pathloss reference signal, wherein the downlink pathloss reference signal is used by the UE to determine an uplink transmit power associated with an uplink resource of the multiple uplink resources.

The transmission component 904 may transmit a set of parameters associated with the first beam sweep pattern, and/or may transmit a set of parameters associated with the second beam sweep pattern.

The transmission component 904 may transmit a first subset of parameters, of the set of parameters, via the DCI, and/or may transmit a second subset of parameters, of the set of parameters, via an RRC configuration.

The transmission component 904 may transmit a first subset of parameters of the set of parameters via the DCI, and/or may transmit a second subset of parameters of the set of parameters via a radio resource control configuration.

The transmission component 904 may transmit an indication of a plurality of beam sweep patterns via an RRC configuration, wherein the RRC configuration indicates an index value associated with each beam sweep pattern of the plurality of beam sweep patterns.

The transmission component 904 may transmit, via the DCI, an indication of an index value associated with the first beam sweep pattern, and/or may transmit, via the DCI, an indication of an index value associated with the second beam sweep pattern.

The determination component 908 may determine to update one or more of the plurality of beam sweep patterns. The transmission component 904 may transmit, via MAC-CE signaling or DCI signaling, one or more updated beam sweep patterns.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving downlink control information (DCI) that indicates a first uplink resource for an acknowledgement or negative acknowledgment (ACK/NACK) feedback report and a second uplink resource for a channel state information (CSI) report; and receiving, via the DCI, an indication of a first beam sweep pattern associated with the first uplink resource and a second beam sweep pattern associated with the second uplink resource.

Aspect 2: The method of Aspect 1, wherein the DCI schedules a downlink communication and an aperiodic CSI reference signal (CSI-RS).

Aspect 3: The method of Aspect 2, wherein the ACK/NACK feedback report is associated with the downlink communication; and wherein the CSI report is associated with the aperiodic CSI-RS.

Aspect 4: The method of any of Aspects 1-3, wherein the first uplink resource or the second uplink resource are at least one of a physical uplink control channel resource or a physical uplink shared channel resource.

Aspect 5: The method of any of Aspects 1-4, wherein the first beam sweep pattern is the same as the second beam sweep pattern.

Aspect 6: The method of any of Aspects 1-4, wherein the first beam sweep pattern is different than the second beam sweep pattern.

Aspect 7: The method of any of Aspects 1-6, wherein the first beam sweep pattern indicates a first set of beams associated with transmitting the ACK/NACK feedback report on the first uplink resource; and wherein the second beam sweep pattern indicates a second set of beams associated with transmitting the CSI report on the second uplink resource.

Aspect 8: The method of any of Aspects 1-7, further comprising: transmitting the ACK/NACK feedback report on the first uplink resource in accordance with the first beam sweep pattern; and transmitting the CSI report on the second uplink resource in accordance with the second beam sweep pattern.

Aspect 9: The method of any of Aspects 1-8, further comprising: receiving an indication to retransmit the CSI report using a third beam sweep pattern.

Aspect 10: The method of Aspect 9, wherein the third beam sweep pattern is based at least in part on a transmission of the ACK/NACK feedback report using the first beam sweep pattern.

Aspect 11: The method of any of Aspects 9-10, wherein the third beam sweep pattern indicates one or more beams included in the first beam sweep pattern.

Aspect 12: The method of any of Aspects 9-11, further comprising: retransmitting the CSI report in accordance with the third beam sweep pattern.

Aspect 13: The method of any of Aspects 1-12, wherein the first beam sweep pattern or the second beam sweep pattern is at least one of: a time division multiplexing beam sweep pattern, a frequency division multiplexing beam sweep pattern, or a spatial division multiplexing beam sweep pattern.

Aspect 14: The method of any of Aspects 1-13, wherein the first beam sweep pattern indicates a first set of one or more beams using indications of transmission configuration indicator states or spatial relation information for the first set of one or more beams; and wherein the second beam sweep pattern indicates a second set of one or more beams using indications of transmission configuration indicator states or spatial relation information for the second set of one or more beams.

Aspect 15: The method of any of Aspects 1-14, wherein at least one of the first beam sweep pattern or the second beam sweep pattern indicates that one or more beams are to be repeated in at least one of different time domain resources or different frequency domain resources.

Aspect 16: The method of any of Aspects 1-15, wherein receiving the DCI that indicates the first uplink resource for the ACK/NACK feedback report and the second uplink resource for the CSI report comprises at least one of: receiving an indication that the first uplink resource is a single uplink resource, or receiving an indication that the second uplink resource is a single uplink resource.

Aspect 17: The method of Aspect 16, wherein receiving, via the DCI, the indication of the first beam sweep pattern associated with the first uplink resource and the second beam sweep pattern associated with the second uplink resource comprises at least one of: receiving an indication that the first beam sweep pattern includes a set of beams that occupy different resources of the single uplink resource associated with the first uplink resource, or receiving an indication that the second beam sweep pattern includes a set of beams that occupy different resources of the single uplink resource associated with the second uplink resource.

Aspect 18: The method of Aspect 17, wherein different resources of the single uplink resource include at least one of: different time domain resources of the single uplink resource, different frequency domain resources of the single uplink resource, or different spatial directions associated with the single uplink resource.

Aspect 19: The method of any of Aspects 17-18, further comprising: determining an uplink transmit power associated with transmitting a set of beams on the single uplink resource associated with the first uplink resource based at least in part on a downlink pathloss reference signal associated with the first uplink resource.

Aspect 20: The method of any of Aspects 17-19, further comprising: determining an uplink transmit power associated with transmitting a set of beams on the single uplink resource associated with the second uplink resource based at least in part on a downlink pathloss reference signal associated with the second uplink resource.

Aspect 21: The method of any of Aspects 1-20, wherein receiving the DCI that indicates the first uplink resource for the ACK/NACK feedback report and the second uplink resource for the CSI report comprises at least one of: receiving an indication that the first uplink resource includes multiple uplink resources, or receiving an indication that the second uplink resource includes multiple uplink resources.

Aspect 22: The method of Aspect 21, wherein receiving, via the DCI, the indication of the first beam sweep pattern associated with the first uplink resource and the second beam sweep pattern associated with the second uplink resource comprises at least one of: receiving the indication of the first beam sweep pattern including an indication of a beam sweep pattern for each uplink resource of the multiple uplink resources associated with the first uplink resource, or receiving the indication of the second beam sweep pattern including an indication of a beam sweep pattern for each uplink resource of the multiple uplink resources associated with the second uplink resource.

Aspect 23: The method of any of Aspects 21-22, further comprising: determining, for each uplink resource of the multiple uplink resources associated with the first uplink resource, an uplink transmit power based at least in part on a downlink pathloss reference signal associated with an uplink resource of the multiple uplink resources.

Aspect 24: The method of any of Aspects 21-23, further comprising: determining, for each uplink resource of the multiple uplink resources associated with the second uplink resource, an uplink transmit power based at least in part on a downlink pathloss reference signal associated with an uplink resource of the multiple uplink resources.

Aspect 25: The method of any of Aspects 1-24, wherein receiving, via the DCI, the indication of the first beam sweep pattern associated with the first uplink resource and the second beam sweep pattern associated with the second uplink resource comprises: receiving a first set of parameters associated with the first beam sweep pattern; and receiving a second set of parameters associated with the second beam sweep pattern.

Aspect 26: The method of Aspect 25, wherein the first set of parameters associated with the first beam sweep pattern and the second set of parameters associated with the second beam sweep pattern indicate at least one of: an uplink resource type, an uplink resource identifier, a quantity of uplink resources, a resource allocation per uplink resource, a quantity of repetitions per uplink resource, a panel identifier per beam, or a downlink pathloss reference signal per uplink resource.

Aspect 27: The method of any of Aspects 25-26, wherein receiving the first set of parameters associated with the first beam sweep pattern comprises: receiving a first subset of parameters, of the first set of parameters, via the DCI; and receiving a second subset of parameters, of the first set of parameters, via a radio resource control configuration.

Aspect 28: The method of any of Aspects 25-27, wherein receiving the second set of parameters associated with the second beam sweep pattern comprises: receiving a first subset of parameters of the second set of parameters via the DCI; and receiving a second subset of parameters of the second set of parameters via a radio resource control configuration.

Aspect 29: The method of any of Aspects 1-28, further comprising: receiving an indication of a plurality of beam sweep patterns via a radio resource control (RRC) configuration, wherein the RRC configuration indicates an index value associated with each beam sweep pattern of the plurality of beam sweep patterns.

Aspect 30: The method of Aspect 29, wherein receiving, via the DCI, the indication of the first beam sweep pattern associated with the first uplink resource and the second beam sweep pattern associated with the second uplink resource comprises: receiving, via the DCI, an indication of a first index value associated with the first beam sweep pattern; and receiving, via the DCI, an indication of a second index value associated with the second beam sweep pattern.

Aspect 31: The method of any of Aspects 29-30, further comprising: receiving, via medium access control (MAC) control element (MAC-CE) signaling or DCI signaling, one or more updated beam sweep patterns.

Aspect 32: A method of wireless communication performed by a base station, comprising: transmitting, to a user equipment (UE), downlink control information (DCI) that indicates a first uplink resource for an acknowledgement or negative acknowledgment (ACK/NACK) feedback report and a second uplink resource for a channel state information (CSI) report; and transmitting, to the UE via the DCI, an indication of a first beam sweep pattern associated with the first uplink resource and a second beam sweep pattern associated with the second uplink resource.

Aspect 33: The method of Aspect 32, wherein the DCI schedules a downlink communication and an aperiodic CSI reference signal (CSI-RS).

Aspect 34: The method of Aspect 33, wherein the ACK/NACK feedback report is associated with the downlink communication; and wherein the CSI report is associated with the aperiodic CSI-RS.

Aspect 35: The method of any of Aspects 32-34, wherein the first uplink resource or the second uplink resource are at least one of a physical uplink control channel resource or a physical uplink shared channel resource.

Aspect 36: The method of any of Aspects 32-35, wherein the first beam sweep pattern is the same as the second beam sweep pattern.

Aspect 37: The method of any of Aspects 32-35, wherein the first beam sweep pattern is different than the second beam sweep pattern.

Aspect 38: The method of any of Aspects 32-37, wherein the first beam sweep pattern indicates a first set of beams associated with transmitting the ACK/NACK feedback report on the first uplink resource; and wherein the second beam sweep pattern indicates a second set of beams associated with transmitting the CSI report on the second uplink resource.

Aspect 39: The method of any of Aspects 32-38, further comprising: receiving the ACK/NACK feedback report on the first uplink resource in accordance with the first beam sweep pattern; and receiving the CSI report on the second uplink resource in accordance with the second beam sweep pattern.

Aspect 40: The method of any of Aspects 32-39, further comprising: determining that the CSI report was not successfully received.

Aspect 41: The method of Aspect 40, further comprising: determining a third beam sweep pattern for a retransmission of the CSI report; and transmitting, to the UE, an indication to retransmit the CSI report using the third beam sweep pattern.

Aspect 42: The method of Aspect 41, wherein determining that the CSI report was not successfully received comprises: determining that the ACK/NACK feedback report was successfully received; and determining that the CSI report was not successfully received; wherein determining the third beam sweep pattern for the retransmission of the ACK/NACK feedback report or the CSI report comprises: determining one or more beams on which the ACK/NACK feedback report was successfully received; and determining a third beam sweep pattern for the retransmission of the CSI report that includes the one or more beams on which the ACK/NACK feedback report was successfully received.

Aspect 43: The method of any of Aspects 41-42, further comprising: receiving a retransmission of the CSI report in accordance with the third beam sweep pattern.

Aspect 44: The method of any of Aspects 32-43, wherein the first beam sweep pattern or the second beam sweep pattern is at least one of: a time division multiplexing beam sweep pattern, a frequency division multiplexing beam sweep pattern, or a spatial division multiplexing beam sweep pattern.

Aspect 45: The method of any of Aspects 32-44, wherein the first beam sweep pattern indicates a first set of one or more beams using indications of transmission configuration indicator states or spatial relation information for the first set of one or more beams; and wherein the second beam sweep pattern indicates a second set of one or more beams using indications of transmission configuration indicator states or spatial relation information for the second set of one or more beams.

Aspect 46: The method of any of Aspects 32-45, wherein at least one of the first beam sweep pattern or the second beam sweep pattern indicates that one or more beams are to be repeated in at least one of different time domain resources or different frequency domain resources.

Aspect 47: The method of any of Aspects 32-46, wherein transmitting the DCI that indicates the first uplink resource for the ACK/NACK feedback report and the second uplink resource for the CSI report comprises at least one of: transmitting an indication that the first uplink resource is a single uplink resource, or transmitting an indication that the second uplink resource is a single uplink resource.

Aspect 48: The method of Aspect 47, wherein transmitting, via the DCI, the indication of the first beam sweep pattern associated with the first uplink resource and the second beam sweep pattern associated with the second uplink resource comprises at least one of: transmitting an indication that the first beam sweep pattern includes a set of beams that occupy different resources of the single uplink resource associated with the first uplink resource, or transmitting an indication that the second beam sweep pattern includes a set of beams that occupy different resources of the single uplink resource associated with the second uplink resource.

Aspect 49: The method of Aspect 48, wherein different resources of the single uplink resource include at least one of: different time domain resources of the single uplink resource, different frequency domain resources of the single uplink resource, or different spatial directions associated with the single uplink resource.

Aspect 50: The method of any of Aspects 48-49, further comprising: transmitting a downlink pathloss reference signal associated with the first uplink resource, wherein the downlink pathloss reference signal associated with the first uplink resource is used by the UE to determine an uplink transmit power associated with transmitting a set of beams on the single uplink resource associated with the first uplink resource.

Aspect 51: The method of any of Aspects 48-50, further comprising: transmitting a downlink pathloss reference signal associated with the second uplink resource, wherein the downlink pathloss reference signal associated with the second uplink resource is used by the UE to determine an uplink transmit power associated with transmitting a set of beams on the single uplink resource associated with the second uplink resource.

Aspect 52: The method of any of Aspects 32-51, wherein transmitting the DCI that indicates the first uplink resource for the ACK/NACK feedback report and the second uplink resource for the CSI report comprises at least one of: transmitting an indication that the first uplink resource includes multiple uplink resources, or transmitting an indication that the second uplink resource includes multiple uplink resources.

Aspect 53: The method of Aspect 52, wherein transmitting, via the DCI, the indication of the first beam sweep pattern associated with the first uplink resource and the second beam sweep pattern associated with the second uplink resource comprises at least one of: transmitting the indication of the first beam sweep pattern including an indication of a beam sweep pattern for each uplink resource of the multiple uplink resources associated with the first uplink resource, or transmitting the indication of the second beam sweep pattern including an indication of a beam sweep pattern for each uplink resource of the multiple uplink resources associated with the second uplink resource.

Aspect 54: The method of any of Aspects 52-53, further comprising: transmitting, for each uplink resource of the multiple uplink resources associated with the first uplink resource, a downlink pathloss reference signal, wherein the downlink pathloss reference signal is used by the UE to determine an uplink transmit power associated with an uplink resource of the multiple uplink resources.

Aspect 55: The method of any of Aspects 52-54, further comprising: transmitting, for each uplink resource of the multiple uplink resources associated with the second uplink resource, a downlink pathloss reference signal, wherein the downlink pathloss reference signal is used by the UE to determine an uplink transmit power associated with an uplink resource of the multiple uplink resources.

Aspect 56: The method of any of Aspects 32-55, wherein transmitting, via the DCI, the indication of the first beam sweep pattern associated with the first uplink resource and the second beam sweep pattern associated with the second uplink resource comprises: transmitting a first set of parameters associated with the first beam sweep pattern; and transmitting a second set of parameters associated with the second beam sweep pattern.

Aspect 57: The method of Aspect 56, wherein the first set of parameters associated with the first beam sweep pattern and the second set of parameters associated with the second beam sweep pattern indicate at least one of: an uplink resource type, an uplink resource identifier, a quantity of uplink resources, a resource allocation per uplink resource, a quantity of repetitions per uplink resource, a panel identifier per beam, or a downlink pathloss reference signal per uplink resource.

Aspect 58: The method of any of Aspects 56-57, wherein transmitting the first set of parameters associated with the first beam sweep pattern comprises: transmitting a first subset of parameters, of the first set of parameters, via the DCI; and transmitting a second subset of parameters, of the first set of parameters, via a radio resource control configuration.

Aspect 59: The method of any of Aspects 56-58, wherein transmitting the second set of parameters associated with the second beam sweep pattern comprises: transmitting a first subset of parameters of the second set of parameters via the DCI; and transmitting a second subset of parameters of the second set of parameters via a radio resource control configuration.

Aspect 60: The method of any of Aspects 32-59, further comprising: transmitting an indication of a plurality of beam sweep patterns via a radio resource control (RRC) configuration, wherein the RRC configuration indicates an index value associated with each beam sweep pattern of the plurality of beam sweep patterns.

Aspect 61: The method of Aspect 60, wherein transmitting, via the DCI, the indication of the first beam sweep pattern associated with the first uplink resource and the second beam sweep pattern associated with the second uplink resource comprises: transmitting, via the DCI, an indication of a first index value associated with the first beam sweep pattern; and transmitting, via the DCI, an indication of a second index value associated with the second beam sweep pattern.

Aspect 62: The method of any of Aspects 60-61, further comprising: determining to update one or more of the plurality of beam sweep patterns; and transmitting, via medium access control (MAC) control element (MAC-CE) signaling or DCI signaling, one or more updated beam sweep patterns.

Aspect 63: An apparatus for wireless communication at a device, comprising a processor; memory coupled with the processor; and instructions stored in the memory and executable by the processor to cause the apparatus to perform the method of one or more of Aspects 1-31.

Aspect 64: A device for wireless communication, comprising a memory and one or more processors coupled to the memory, the one or more processors configured to perform the method of one or more of Aspects 1-31.

Aspect 65: An apparatus for wireless communication, comprising at least one means for performing the method of one or more of Aspects 1-31.

Aspect 66: A non-transitory computer-readable medium storing code for wireless communication, the code comprising instructions executable by a processor to perform the method of one or more of Aspects 1-31.

Aspect 67: A non-transitory computer-readable medium storing a set of instructions for wireless communication, the set of instructions comprising one or more instructions that, when executed by one or more processors of a device, cause the device to perform the method of one or more of Aspects 1-31.

Aspect 68: An apparatus for wireless communication at a device, comprising a processor; memory coupled with the processor; and instructions stored in the memory and executable by the processor to cause the apparatus to perform the method of one or more of Aspects 32-62.

Aspect 69: A device for wireless communication, comprising a memory and one or more processors coupled to the memory, the one or more processors configured to perform the method of one or more of Aspects 32-62.

Aspect 70: An apparatus for wireless communication, comprising at least one means for performing the method of one or more of Aspects 32-62.

Aspect 71: A non-transitory computer-readable medium storing code for wireless communication, the code comprising instructions executable by a processor to perform the method of one or more of Aspects 32-62.

Aspect 72: A non-transitory computer-readable medium storing a set of instructions for wireless communication, the set of instructions comprising one or more instructions that, when executed by one or more processors of a device, cause the device to perform the method of one or more of Aspects 32-62.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code-it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving downlink control information (DCI) that indicates a first uplink resource for an acknowledgement or negative acknowledgment (ACK/NACK) feedback report and a second uplink resource for a channel state information (CSI) report; and
receiving, via the DCI, an indication of a first beam sweep pattern associated with the first uplink resource and a second beam sweep pattern associated with the second uplink resource.

2. The method of claim 1, wherein the first beam sweep pattern is the same as the second beam sweep pattern.

3. The method of claim 1, wherein the first beam sweep pattern is different than the second beam sweep pattern.

4. The method of claim 1, wherein the first beam sweep pattern indicates a first set of beams associated with transmitting the ACK/NACK feedback report on the first uplink resource; and
wherein the second beam sweep pattern indicates a second set of beams associated with transmitting the CSI report on the second uplink resource.

5. The method of claim 1, further comprising:
transmitting the ACK/NACK feedback report on the first uplink resource in accordance with the first beam sweep pattern; and
transmitting the CSI report on the second uplink resource in accordance with the second beam sweep pattern.

6. The method of claim 1, further comprising:
receiving an indication to retransmit the CSI report using a third beam sweep pattern.

7. The method of claim 6, wherein the third beam sweep pattern is based at least in part on a transmission of the ACK/NACK feedback report using the first beam sweep pattern.

8. The method of claim 1, wherein the first beam sweep pattern or the second beam sweep pattern is at least one of:
a time division multiplexing beam sweep pattern,
a frequency division multiplexing beam sweep pattern, or
a spatial division multiplexing beam sweep pattern.

9. The method of claim 1, wherein at least one of the first beam sweep pattern or the second beam sweep pattern indicates that one or more beams are to be repeated in at least one of different time domain resources or different frequency domain resources.

10. The method of claim 1, wherein receiving, via the DCI, the indication of the first beam sweep pattern associated with the first uplink resource and the second beam sweep pattern associated with the second uplink resource comprises:
receiving a first set of parameters associated with the first beam sweep pattern; and
receiving a second set of parameters associated with the second beam sweep pattern.

11. A method of wireless communication performed by a base station, comprising:
transmitting, to a user equipment (UE), downlink control information (DCI) that indicates a first uplink resource for an acknowledgement or negative acknowledgment (ACK/NACK) feedback report and a second uplink resource for a channel state information (CSI) report; and
transmitting, to the UE via the DCI, an indication of a first beam sweep pattern associated with the first uplink resource and a second beam sweep pattern associated with the second uplink resource.

12. The method of claim 11, further comprising:
receiving the ACK/NACK feedback report on the first uplink resource in accordance with the first beam sweep pattern; and
receiving the CSI report on the second uplink resource in accordance with the second beam sweep pattern.

13. The method of claim 11, wherein transmitting the DCI that indicates the first uplink resource for the ACK/NACK feedback report and the second uplink resource for the CSI report comprises at least one of:
transmitting an indication that the first uplink resource is a single uplink resource, or
transmitting an indication that the second uplink resource is a single uplink resource.

14. The method of claim 11, further comprising:
transmitting an indication of a plurality of beam sweep patterns via a radio resource control (RRC) configuration, wherein the RRC configuration indicates an index value associated with each beam sweep pattern of the plurality of beam sweep patterns.

15. The method of claim 14, wherein transmitting, via the DCI, the indication of the first beam sweep pattern associated with the first uplink resource and the second beam sweep pattern associated with the second uplink resource comprises:
transmitting, via the DCI, an indication of a first index value associated with the first beam sweep pattern; and
transmitting, via the DCI, an indication of a second index value associated with the second beam sweep pattern.

16. A user equipment (UE) for wireless communication, comprising:
a memory; and
one or more processors, coupled to the memory, configured to:
receive downlink control information (DCI) that indicates a first uplink resource for an acknowledgement or negative acknowledgment (ACK/NACK) feedback report and a second uplink resource for a channel state information (CSI) report; and
receive, via the DCI, an indication of a first beam sweep pattern associated with the first uplink resource and a second beam sweep pattern associated with the second uplink resource.

17. The UE of claim 16, wherein the first beam sweep pattern is the same as the second beam sweep pattern.

18. The UE of claim 16, wherein the first beam sweep pattern is different than the second beam sweep pattern.

19. The UE of claim 16, wherein the first beam sweep pattern indicates a first set of beams associated with transmitting the ACK/NACK feedback report on the first uplink resource; and
wherein the second beam sweep pattern indicates a second set of beams associated with transmitting the CSI report on the second uplink resource.

20. The UE of claim 16, wherein the one or more processors are further configured to:
transmit the ACK/NACK feedback report on the first uplink resource in accordance with the first beam sweep pattern; and
transmit the CSI report on the second uplink resource in accordance with the second beam sweep pattern.

21. The UE of claim 16, wherein the one or more processors are further configured to: receive an indication to retransmit the CSI report using a third beam sweep pattern.

22. The UE of claim 21, wherein the third beam sweep pattern is based at least in part on a transmission of the ACK/NACK feedback report using the first beam sweep pattern.

23. The UE of claim 16, wherein the first beam sweep pattern or the second beam sweep pattern is at least one of:
a time division multiplexing beam sweep pattern,
a frequency division multiplexing beam sweep pattern, or
a spatial division multiplexing beam sweep pattern.

24. The UE of claim 16, wherein at least one of the first beam sweep pattern or the second beam sweep pattern indicates that one or more beams are to be repeated in at least one of different time domain resources or different frequency domain resources.

25. The UE of claim 16, wherein the one or more processors, to receive, via the DCI, the indication of the first beam sweep pattern associated with the first uplink resource and the second beam sweep pattern associated with the second uplink resource, are configured to:
receive a first set of parameters associated with the first beam sweep pattern; and
receive a second set of parameters associated with the second beam sweep pattern.

26. A base station for wireless communication, comprising:
a memory; and
one or more processors, coupled to the memory, configured to:
transmit, to a user equipment (UE), downlink control information (DCI) that indicates a first uplink resource for an acknowledgement or negative acknowledgment (ACK/NACK) feedback report and a second uplink resource for a channel state information (CSI) report; and
transmit, to the UE via the DCI, an indication of a first beam sweep pattern associated with the first uplink resource and a second beam sweep pattern associated with the second uplink resource.

27. The base station of claim 26, wherein the one or more processors are further configured to:
receive the ACK/NACK feedback report on the first uplink resource in accordance with the first beam sweep pattern; and
receive the CSI report on the second uplink resource in accordance with the second beam sweep pattern.

28. The base station of claim 26, wherein the one or more processors, to transmit the DCI that indicates the first uplink resource for the ACK/NACK feedback report and the second uplink resource for the CSI report, are configured to:
transmit an indication that the first uplink resource is a single uplink resource, or
transmit an indication that the second uplink resource is a single uplink resource.

29. The base station of claim 26, wherein the one or more processors are further configured to:
transmit an indication of a plurality of beam sweep patterns via a radio resource control (RRC) configuration, wherein the RRC configuration indicates an index value associated with each beam sweep pattern of the plurality of beam sweep patterns.

30. The base station of claim 29, wherein the one or more processors, to transmit, via the DCI, the indication of the first beam sweep pattern associated with the first uplink resource and the second beam sweep pattern associated with the second uplink resource, are configured to:
transmit, via the DCI, an indication of a first index value associated with the first beam sweep pattern; and
transmit, via the DCI, an indication of a second index value associated with the second beam sweep pattern.
